(19) United States
(12) Patent Application Publication
(10) Pub. No.: US 2003/0213653 A1
(43) Pub. Date: Nov. 20, 2003

(54) Wheelchair lift for a stage

(75) Inventor: Don Morris, Conifer, CO (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Lift-U, a Division of Hogan Mfg., Inc.

(21) Appl. No.: 10/377,267

(22) Filed: Feb. 28, 2003

Related U.S. Application Data
(60) Provisional application No. 60/361,909, filed on Feb. 28, 2002.
(60) Provisional application No. 60/412,270, filed on Sep. 19, 2002.

(51) Int. Cl. B66F 3/22; B66B 9/02

(52) U.S. Cl. 187/269; 187/200; 254/122

(57) ABSTRACT

A wheelchair lift assembly is provided. The wheelchair lift assembly is adapted to be disposed in a cavity located below a lower surface when in a stowed position. The wheelchair lift assembly includes a lift platform and a lifting mechanism coupled to the lift platform for reciprocating the lift platform between a lowered position, wherein the lift platform is substantially coplanar with the lower surface, and a raised position, wherein the lift platform is substantially coplanar with an upper surface. The wheelchair lift assembly also includes a lift platform barrier coupled to one end of the lift platform and a lift platform barrier actuating assembly coupled to the lift platform barrier. The lift platform barrier actuating assembly actuates the lift platform barrier between a retracted position, wherein the lift platform barrier is disposed substantially flush or below the lift platform to permit access to the lift platform, and an extended position, wherein at least a portion of the lift platform barrier extends above the lift platform to impede access to the lift platform.

### CROSS-REFERENCE TO RELATED APPLICATION

This application claims the benefit of U.S. Provisional Patent Application Serial No. 60/361,909, filed on Feb. 28, 2002, and Serial No. 60/412,270, filed on Sep. 19, 2002, priority from the filing dates of which is hereby claimed under 35 U.S.C. §119 and the disclosures of which are hereby expressly incorporated by reference.

### FIELD OF THE INVENTION

The present invention is directed generally to wheelchair lifts, and more particularly, to wheelchair lifts having retractable barriers to selectively impede ingress and egress from the wheelchair lift.

### BACKGROUND OF THE INVENTION

Lifts are often used to provide a mode of transporting a wheelchair bound or mobility impaired person between floors of different elevations, such as from the main floor of a theater or school multi-purpose room to an elevated stage. Existing lift products may include stationary designs that require dedicated rooms for accessibility to lift operation, or portable designs that must be maneuvered into position for lift operation and require closets or area for storage. Thus, there exists a need for a retractable lift that is stowed out-of-sight within the main floor until the device is needed to transport mobility impaired persons from the main floor to an elevated floor.

It is advisable, or required by regulations, such as those promulgated by the ANSI/ASME A18.1-1999 Safety Standard for Platform Lifts and Stairway Chairlifts, to provide a retractable barrier to resist people on the elevated floor from falling or contacting the lift during use. Although retractable barriers are available for this purpose, they are not without their problems.

For instance, many retractable barriers include a single panel that swings from a stowed position to a deployed position. This is disadvantageous for several reasons. First, a large area free of obstructions must be provided to allow the panel to be swung between the stowed and deployed position, thus limiting the use of the space in the vicinity of the retractable barrier. Further, the panel may impact a person or an object during the swinging motion of the panel, causing injury or damage. Thus, there exists a need for a lift assembly with a retractable barrier with a minimal swing area that not only provides the desired barrier protection, but also is economical to manufacture, has a high degree of reliability, and satisfies the performance expectations of the end user.

### SUMMARY OF THE INVENTION

A wheelchair lift assembly is provided. The wheelchair lift assembly is adapted to be disposed in a cavity located below a lower surface when in a stowed position. The wheelchair lift assembly includes a lift platform and a lifting mechanism coupled to the lift platform for reciprocating the lift platform between a lowered position, wherein the lift platform is substantially coplanar with the lower surface, and a raised position, wherein the lift platform is substantially coplanar with an upper surface. The wheelchair lift assembly also includes a lift platform barrier coupled to one end of the lift platform and a lift platform barrier actuating assembly coupled to the lift platform barrier. The lift platform barrier actuating assembly actuates the lift platform barrier between a retracted position, wherein the lift platform barrier is disposed substantially flush or below the lift platform to permit access to the lift platform, and an extended position, wherein at least a portion of the lift platform barrier extends above the lift platform to impede access to the lift platform.

In one embodiment formed in accordance with the present invention, the lift platform barrier actuating assembly includes an actuator for displacing the lift platform barrier between the retracted and extended positions. In certain embodiments, the actuator includes a cam surface and a cam follower. The cam follower engages the cam surface to selectively actuate the lift platform barrier between the retracted and extended positions.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a front isometric view of a lift and upper floor barrier assembly formed in accordance with one embodiment of the present application, showing a lift platform raised to a height substantially coplanar with an upper floor surface;

FIG. 2 is a partial exploded isometric view of the lift assembly shown in FIG. 1, wherein a lifting mechanism of the lift assembly is shown in exploded form;

FIG. 3 is an exploded isometric view of the lift platform, handrails, and handrail actuating assembly taken from the back of the lift assembly shown in FIG. 1;

FIG. 4 is a partial isometric exploded view of a portion of the handrail actuating assembly depicted in FIG. 3;

FIG. 5 is a back elevation view of the lift assembly with a cover removed to better show the installed configuration of the handrail actuating assembly depicted in FIG. 3, wherein the handrails are shown in their stowed positions;

FIG. 6 is a back elevation view of the lift assembly depicting the installed configuration of the handrail actuating assembly depicted in FIG. 3, wherein the handrails are shown in a partially deployed position;

FIG. 7 is a back elevation view of the lift assembly depicting the installed configuration of the handrail actuating assembly depicted in FIG. 3, wherein the handrails are shown in their deployed positions;

FIG. 8 is a front isometric exploded view of the lift platform and lift platform barrier actuating assembly shown in FIG. 2, wherein the handrails have been removed for clarity;

FIG. 9 is a partial isometric exploded view of a portion of the lift platform barrier actuating assembly depicted in FIG. 8;

FIG. 10 is a front elevation view of the lift assembly with a cover removed to better show the installed configuration of the lift platform barrier actuating assembly depicted in FIG. 8, depicted with the lift platform barrier in the stowed position;

FIG. 11 is a front elevation view of the lift assembly depicting the installed configuration of the lift platform barrier actuating assembly depicted in FIG. 10, the lift assembly depicted when the lift platform barrier is in a partially deployed position;

FIG. 12 is a front elevation view of the lift assembly depicting the installed configuration of the lift platform barrier actuating assembly depicted in FIG. 11, the lift assembly depicted when the lift platform barrier is in the fully deployed position;

FIG. 13 is an isometric view of the upper floor barrier assembly formed in accordance with one embodiment of the present application, showing the barrier in a deployed position;

FIG. 14 is an isometric view of a lift assembly having an upper floor barrier assembly formed in accordance with one embodiment of the present invention, showing the lift assembly and upper floor barrier assembly in a stowed position;

FIG. 15 is an isometric view of the lift and upper floor barrier assembly shown in FIG. 14, showing the upper floor barrier assembly in a deployed position;

FIG. 16 is an isometric view of the lift assembly shown in FIG. 14, the lift assembly depicted with the upper floor barrier assembly and cover panels depicted in deployed positions;

FIG. 17 is an isometric view of the lift assembly shown in FIG. 14, the lift assembly depicted with the upper floor barrier assembly, cover panels, and handrails depicted in deployed positions, and wherein the lift platform has risen from a stowed level to a lower floor level such that the lift platform is coplanar with the lower floor;

FIG. 18 is an isometric view of the lift assembly shown in FIG. 17, the lift assembly depicted with an upper floor barrier deployed to impede ingress and egress from the lift platform;

FIG. 19 is an isometric view of lift assembly shown in FIG. 1, wherein the upper floor barrier assembly has been retracted to permit ingress and egress from the lift platform;

FIG. 20 is an isometric view of a lift assembly in combination with a retractable barrier formed in accordance with another embodiment of the present invention, wherein the retractable barrier is shown mounted to a wall of an upper floor located adjacent and above the lift assembly, wherein the retractable barrier and the lift assembly are both shown in a stowed position;

FIG. 21 is an isometric view of the retractable barrier depicted in FIG. 20, the retractable barrier depicted in the stowed position;

FIG. 22 is an isometric view of the retractable barrier depicted in FIG. 20, showing the retractable barrier in a 75% deployed position;

FIG. 23 is a cross-sectional view of the retractable barrier of FIG. 22, taken substantially through Section 23-23 of FIG. 22, showing the actuating assembly in a 75% deployed position;

FIG. 24 is an isometric view of the retractable barrier shown in FIG. 20, showing the retractable barrier in a 25% deployed position, wherein an outer panel and an inner panel are shown in phantom to better illustrate the components of a drive assembly;

FIG. 25 is a cross-sectional view of the retractable barrier depicted in FIG. 24, the cross sectional cut taken substantially through Section 25-25 of FIG. 24, showing the actuating assembly in a 25% deployed position;

FIG. 26 is an isometric view of the retractable barrier shown in FIG. 20, the retractable barrier depicted in a fully deployed configuration; and

FIG. 27 is a cross-sectional view of the retractable barrier depicted in FIG. 26, the cross sectional cut taken substantially through Section 27-27 of FIG. 26, showing the barrier actuating assembly in the fully deployed position.

### DETAILED DESCRIPTION OF THE PREFERRED EMBODIMENT

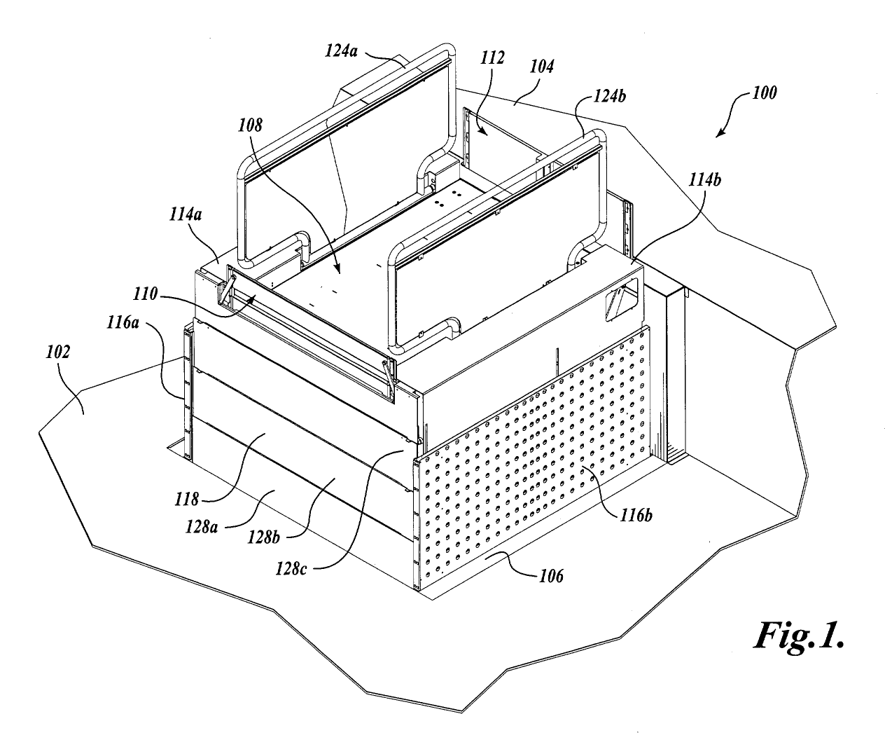

FIG. 1 illustrates a lift assembly 100 formed in accordance with one embodiment of the present invention. The lift assembly 100 permits a mobility impaired person (not shown) to be conveyed from a lower floor 102 to an upper floor 104, such as a stage. Referring to FIG. 1, the lift assembly 100 includes a frame 106, a lift platform 108, a lift platform barrier 110, an upper floor barrier 112, a pair of side curbs 114a and 114b, a pair of cover panels 116a and 116b, a protective apron 118, and a pair of handrails 124a and 124b.

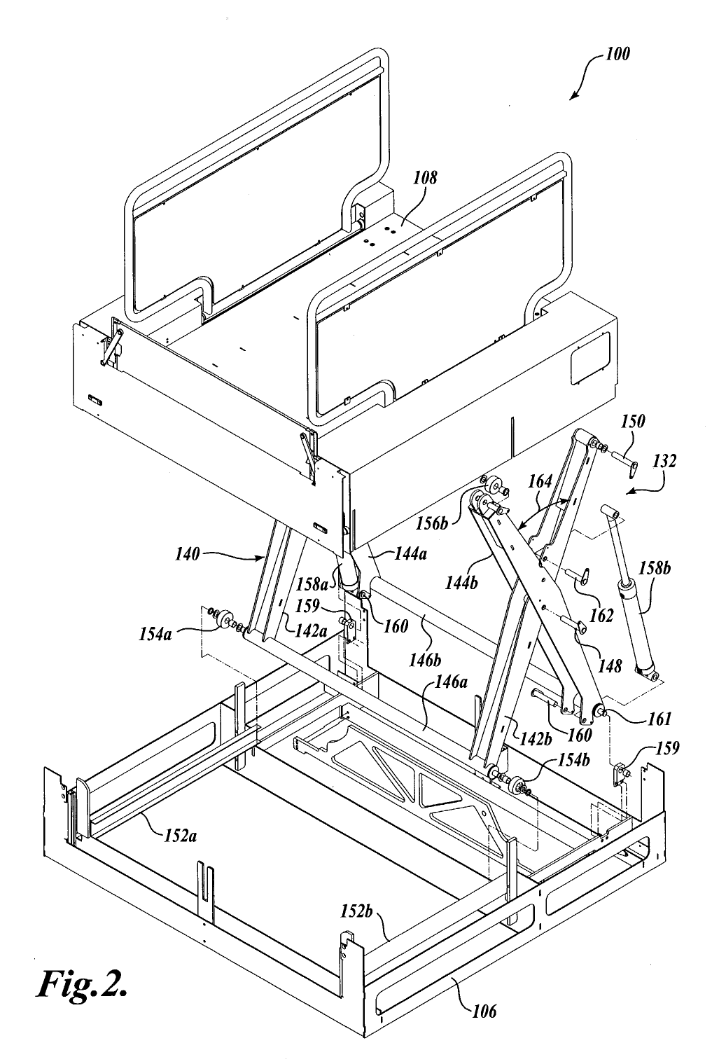

As may be best seen by referring to FIGS. 2-19, the subsystems and components of an actuation system that controls the operation of the lift assembly 100 will now be described. The actuation system includes a lifting assembly 132, a handrail actuating assembly 134, a lift platform barrier actuating assembly 136, an upper floor actuating barrier assembly 138, and a cover panel actuating assembly 139.

As best seen by referring to FIG. 2, the lifting assembly 132 includes a scissors jack 140. The scissors jack 140 is formed from a first pair of spaced struts 142a and 142b pivotally coupled to a second pair of spaced struts 144a and 144b. The lower ends of struts 142a and 142b are coupled to one another by a first support tube 146a to increase the rigidity of the struts 142a and 142b. Likewise, the lower ends of struts 144a and 144b are coupled to one another by a second support tube 146b. The pairs of struts 142 and 144 are pivotally coupled to one another by well known pivot pins 148 (one shown) at about the middle of each strut 142 and 144.

The upper ends of struts 142a and 142b are pivotally coupled to the lift platform 108 by a pair of pivot pins 150 (one shown). A pair of rollers 154A and 154B are coupled to the lower distal ends of struts 142a and 142b. The rollers 154 engage a pair of horizontally oriented guide tracks 152a and 152b coupled to the frame 106. Similarly, a pair of rollers 156B (one shown) are coupled to the upper distal ends of struts 144a and 144b. The rollers 156 engage a pair of horizontally oriented guide tracks (not shown, but which are similar to guide tracks 152) coupled to the lift platform 108. The lower ends of struts 144a and 144b are pivotally coupled to frame 106 by a pair of stub shafts 161 extending from each end of the second support tube 146b and engage a pair of retainer plates 159 that are rigidly attached to frame 106.

The lower ends of a pair of actuators 158a and 158b are pivotally coupled to the lower ends of the second pair of struts 144 by pivot pins 160. The upper ends of the actuators 158 are coupled to the first pair of struts 142 at a location between the upper ends of the struts 142 and the location wherein the struts 142 and 144 are pivotally coupled to one another. The location of the attachment of the actuators 158a and 158b to the struts 142 and 144 is preferably selected such that actuation of the actuators 158a and 158b is optimized. The upper ends of the actuators 158a and 158b are coupled to the struts 142 by pivot pins 162 (one shown).

The actuators 158 are adjustable in length. Increasing the length of the actuators 158 causes a resultant decrease in a separation angle 164 defined by the angle between opposing pairs of struts 142 and 144. By decreasing the separation angle 164, the scissors jack 140 causes the lift platform 108 to raise in elevation. By increasing the separation angle 164, the scissors jack 140 causes the lift platform 108 to lower, as should be apparent to those skilled in the art and others. In the illustrated embodiment, the actuators 158 are formed from well known hydraulic pistons, however it should be apparent to those skilled in the art that other type of actuators are suitable for use and within the spirit and scope of the present invention, such as electrical solenoid actuators, mechanical actuators, etc.

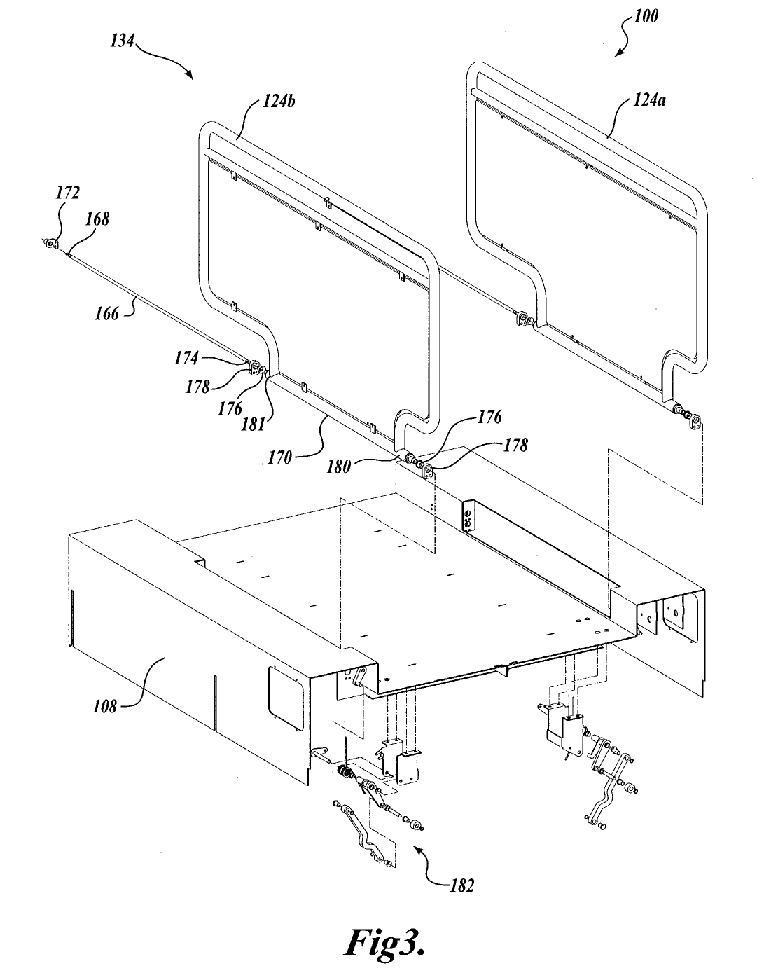

Referring to FIG. 3, the detailed description will now focus upon the handrail actuating assembly 134. Inasmuch as the components of the handrail actuating assembly 134 are substantially similar for each handrail 124a and 124b, this detailed description, for the sake of brevity, will describe the components of the handrail actuating assembly 134 associated with handrail 124b only. Where the context permits, reference in the following description to an element of the handrail actuating assembly 134 associated with handrail 124b shall be understood as also referring to the corresponding element in the portion of the handrail actuating assembly 134 associated with handrail 124a.

The handrail actuating assembly 134 includes a torsion rod 166. A first end 168 of the torsion rod 166 is rigidly coupled to the lift platform 108 by a well known fastener 172. The torsion rod 166 passes through a guide tube 170 formed with the handrail 124b. A second end 174 of the torsion rod 166 is keyed to a first end 180 of the guide tube 170. The guide tube 170 is supported at opposite ends 180 and 181 by bearings 176 and bearing holders 178 coupled to the lift platform 108 in a well known manner. Thus, rotation of the handrail 124b causes a build up or release of torsional tension within the torsion rod 166.

In the illustrated embodiment, the torsion rod 166 is suitably preloaded with a torsional force upon the handrail 124b to bias the handrail 124b toward the deployed position. As such, the preload counteracts the forces of gravity acting upon the handrail 124b tending to pull the handrail 124b toward the stowed position. Thus, substantially no force other than that supplied by torsion rod 166 is required to actuate the handrail 124b between the stowed and the deployed positions.

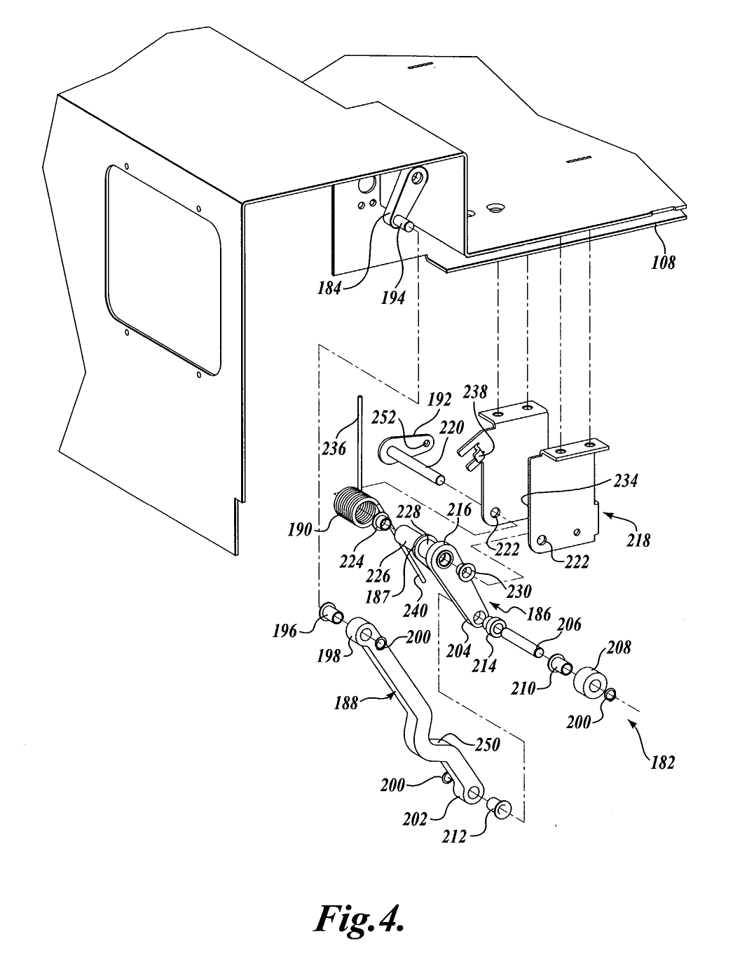

The handrail actuating assembly 134 includes an actuation control assembly 182. The actuation control assembly 182 operates to selectively control the deployment of handrail 124b from its respective stowed position to its deployed position. As best seen by referring to FIG. 4, the actuation control assembly 182 includes first and second levers 184 and 186, a connecting rod 188, a torsion spring 190, and a spindle 192. The first lever 184 is rigidly coupled to end 180 of guide tube 170, such that rotation of guide tube 170 causes a corresponding rotation of the first lever 184. The first lever 184 includes a shaft 194 extending perpendicularly outward from one end of the first lever 184. The shaft 194 is sized to be rotatingly received within a bushing 196 disposed in a first end 198 of the connecting rod 188 and secured with a well known fastener, such as a retaining clip 200.

A second end 202 of the connecting rod 188 is coupled to a first end 204 of the second lever 186 by a shaft 206. The shaft 206 is sized to pass through bushings 212 and 214 disposed in the second end 202 of the connecting rod 188 and the first end 204 of the second lever 186 respectively, and is secured in place by well known fasteners, such as retaining clips 200. Also secured on the shaft 206 is a roller 208 which is rotatingly received by a bushing 210.

A second end 216 of the second lever 186 is pivotally coupled to a mounting bracket 218 rigidly coupled to the lift platform 108. The second end 216 of the second lever 186 is coupled to the mounting bracket 218 by passing a shaft 220 of the spindle 192 through a pair of opposing apertures 222 in the mounting bracket 218. The shaft 220 passes through the center of the torsion spring 190, a first bushing 224, a collar 226 (collar 226 is rigidly attached to second lever 186 and adapted to rotatingly receive the torsion spring 190), and a second bushing 230. The spindle 192 is coupled to the mounting bracket 218 by passing a well known fastener (not shown), such as a threaded fastener, through aperture 252 in the spindle 192 and coupling the fastener to a corresponding aperture 234 in the mounting bracket 218.

As noted above, the torsion spring 190 is rotatingly received by the collar 226. A first end 236 of the torsion spring 190 is received by a first retainment structure 238 disposed on the mounting bracket 218. A second end 240 of the torsion spring 190 is retained upon a second retainment lever 187 (not shown in its entirety) rigidly attached to collar 226. The torsion spring 190 acts upon the second retainment lever 187 to bias rotation of the second lever 186 in a counterclockwise direction.

Referring now to FIGS. 4-7, the operation of the actuation control assembly 182 during deployment of the handrail 124b will be described. The rotation of the second lever 186 is controlled by interaction with a cam surface 244 formed on a cam plate 242 coupled to the frame 106. The roller 208 (i.e., cam follower) coupled to the second end 202 of the connecting rod 188 and the first end 204 of the second lever 186 rides upon the cam surface 244 to selectively control the rotation of the handrail 124b.

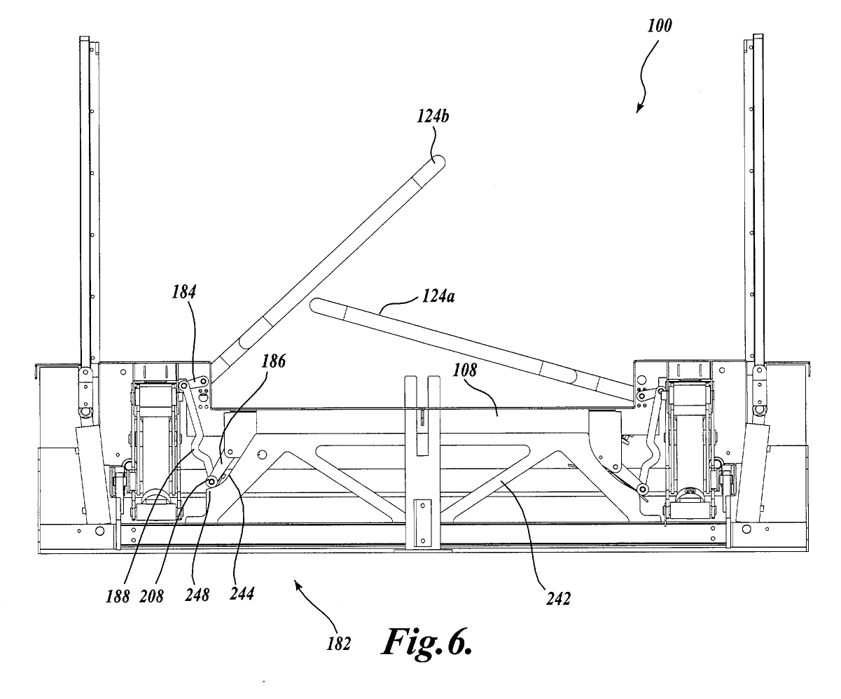

Referring to FIG. 6, as the lift platform 108 is raised, the roller 208 passes over a ridge 248. As the roller 208 passes onto the cam surface 244, the second lever 186 begins to rotate in the counterclockwise direction about shaft 220. This enables connecting rod 188 to move, thus allowing first lever 184 to rotate in a counterclockwise direction.

The roller 208 is biased to engage the stop surface 246 and the cam surface 244 by the torsion spring 190 (see FIG. 4) and torsion rod 166 acting through first lever 184. As the roller 208 passes along the cam surface 244 and is rotated and due to the increase in separation distance between the actuation control assembly 182 from the cam plate 242, the first lever 184 is further rotated counterclockwise. Rotation of the first lever 184 causes a corresponding rotation of the handrail 124b from its stowed position to its deployed position. As the lift platform 108 is raised further, the roller 208 disengages from the cam plate 242.

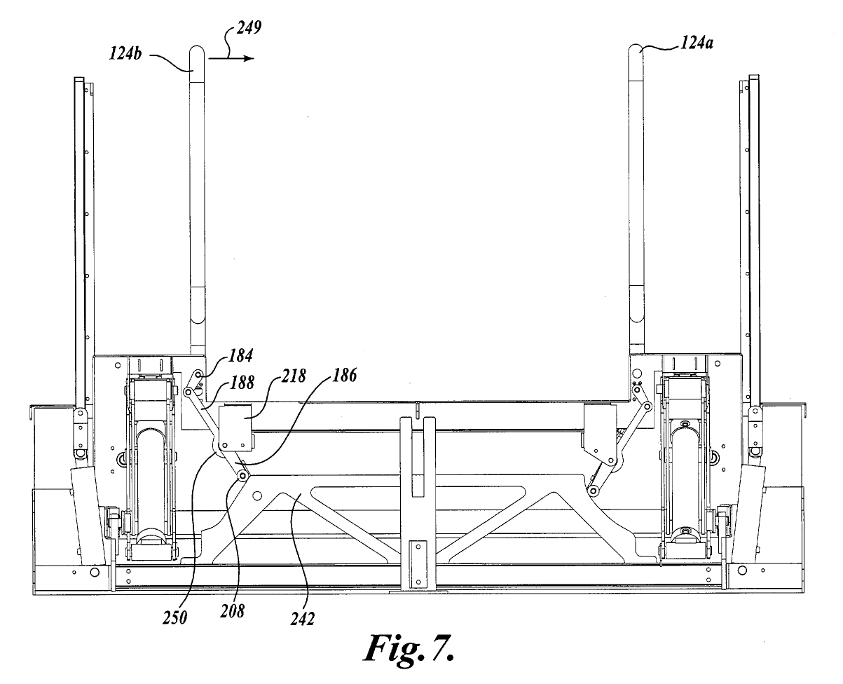

Referring to FIGS. 4 and 7, the handrail 124b is locked in the fully deployed position by restricting the movement of the connecting rod 188. More specifically, surface 228 engages the connecting rod 188 to impede the movement of the connecting rod 188. Moreover, when the handrail 124b is in the fully deployed position, the surface 228 engages a bend or notch 250 in the connecting rod 188. The engagement of the surface 228 within the notch 250 of the connecting rod 188 prevents the second lever 186 from any further rotation in the counterclockwise direction, thereby preventing the over rotation of the handrail 124b past the deployed position shown in FIG. 7.

Further, due to the near or actual linear alignment of the connecting rod 188 relative to the second lever 186, the handrail 124b is further locked in the deployed position. The surface 228 restricts the connecting rod 188 from rotating in a clockwise direction. The restriction of the connecting rod 188 from rotating in the clockwise direction is accomplished by the near or actual linear alignment of the connecting rod 188 and the second lever 186. This alignment of the connecting rod 188 and second lever 186 effectively locks the handrail 124b from rotating by a force applied to the handrail 124b. The bias of spring 190 acting against the second retainment lever 187 causes notch 250 of connecting rod 188 to bear against surface 228 resulting in a toggle-lock.

If a force is applied to the handrail 124b in the direction of the arrow indicated by reference numeral 249, the force would first have to overcome the preload applied by the torsion rod 166. Any remaining force would then tend rotate the first lever 184 in a counterclockwise direction. Rotation of the first lever 184 causes a corresponding force upon the connecting rod 188 longitudinally along its length. This force is transferred to the second lever 186. However, rotation of any of the levers 184 and 186, and the connecting rod 188 is impeded because the second lever 186 is substantially linearly aligned with the connecting rod 188, thus any force applied to the connecting rod 188 is transferred to the second lever 186.

A force creating a counterclockwise moment upon the connecting rod 188 is required to free the connecting rod 188 and handrail 124b from the locked position. To release the handrail 124b and connecting rod 188 from the locked position, a clockwise moment is applied to the connecting rod 188 by interaction of the roller 208 with the cam plate 242. This clockwise moment must first overcome the bias of spring 190 thereby causing the handrail 124b to rotate back to the stowed position.

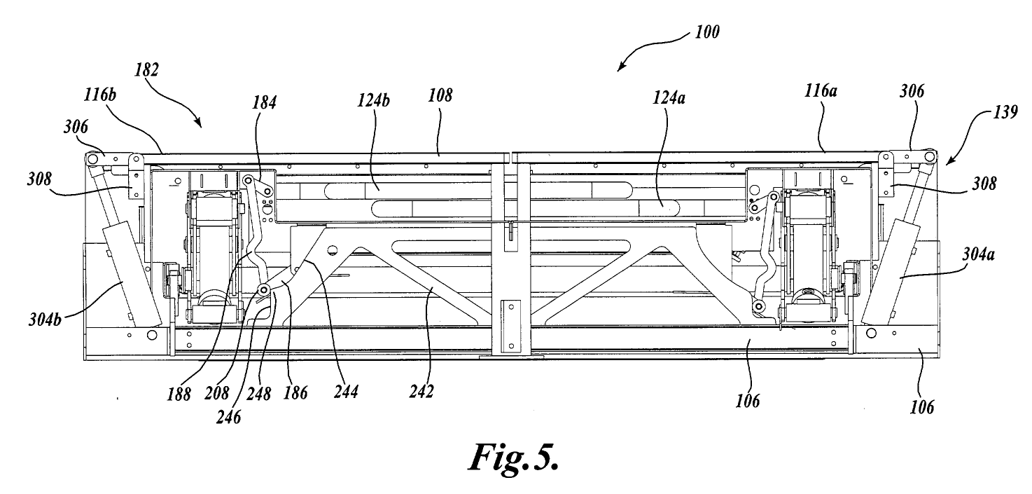

Referring to FIGS. 5 and 6, handrails 124a and 124b in conjunction with respective actuating control assemblies 182 and cam plate 242, are configured such that handrail 124b is operatively located above handrail 124a to deploy handrail 124b slightly ahead of handrail 124a, thus timing the handrail deployment to avoid interference between handrails 124a and 124b. Although the illustrated embodiment of the present invention is depicted with the handrails, lift platform barrier, and lift platform moving simultaneously, it should be apparent to one skilled in the art that the actuation of the handrails, lift platform barrier, and lift platform could be performed sequentially.

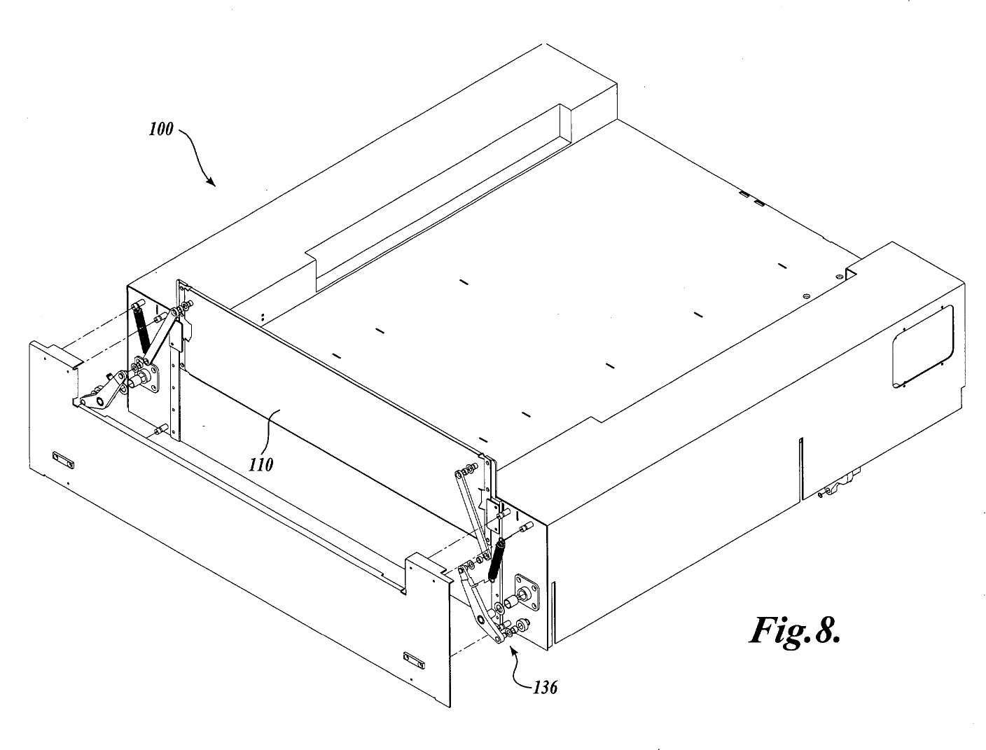

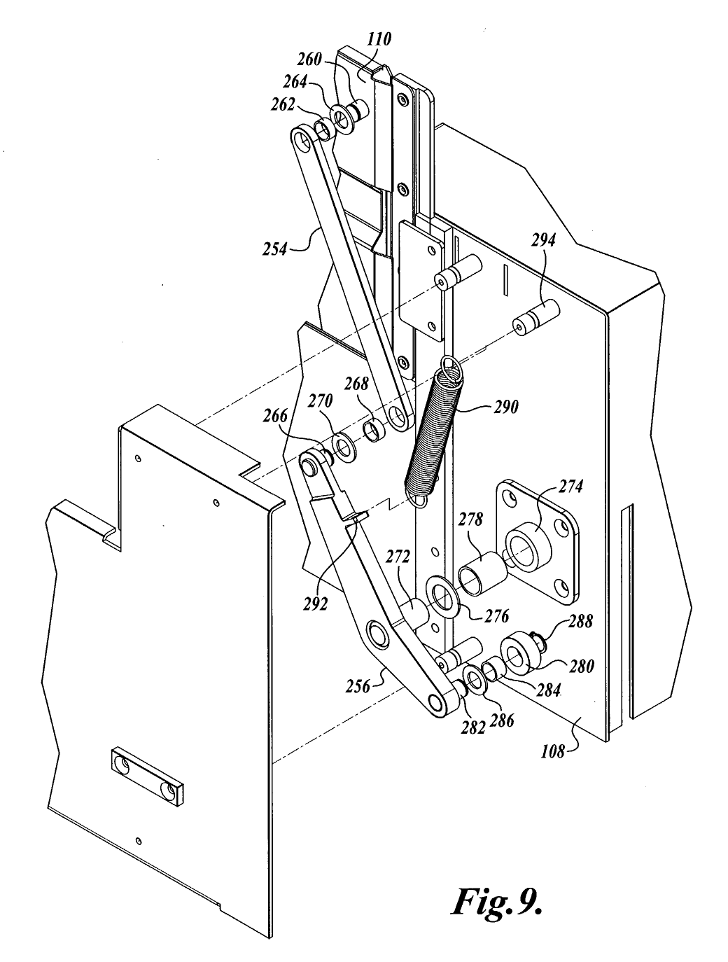

Referring now to FIGS. 8 and 9, the detailed description will now focus upon the lift platform barrier actuating assembly 136. Inasmuch as the components of the lift platform barrier actuating assembly 136 are substantially similar for each side of the lift platform barrier 110, this detailed description, for the sake of brevity, will describe the components of the lift platform barrier actuating assembly 136 associated with one side of the lift platform barrier only. Where the context permits, reference in the following description to an element of one side of the lift platform barrier actuating assembly 136 shall be understood as also referring to the corresponding element of the opposite side of the lift platform barrier actuating assembly 136.

Each side of the lift platform barrier actuating assembly 136 includes a first lever 254 and a second lever 256. The upper end of the first lever 254 is pivotally coupled to a stub shaft 260 coupled to the lift platform barrier 110, including a well known bushing 262 and washer 264. The lower end of the first lever 254 is coupled to a pivot pin 266 extending perpendicularly outward from the upper end of the second lever 256. A well known bushing 268 and a washer 270 are used to reduce rotational friction and wear between the first and second levers 254 and 256. The second lever 256 is rotatingly coupled to the lift platform 108 by a pivot shaft 272 of the second lever 256 and a bearing holder 274 coupled to the lift platform 108. A washer 276 and a bearing 278 are used to reduce rotational friction and wear between the pivot shaft 272 and the bearing holder 274.

Pivotally coupled to the lower end of the second lever 256 is a cam follower 280. The cam follower 280 is mounted upon a pivot shaft 282 extending perpendicularly outward from the lower end of the second lever 256. The cam follower 280 is rotatingly received upon the pivot shaft 282 by a bushing 284 and a washer 286, and is removably retained upon the pivot shaft 282 by a well known retaining clip 288. A spring 290 extends between a lip 292 disposed on the second lever 256 and a post 294 extending perpendicularly outward from the lift platform 108. The spring 290 biases the second lever 256 in a clockwise rotation about the pivot shaft 272.

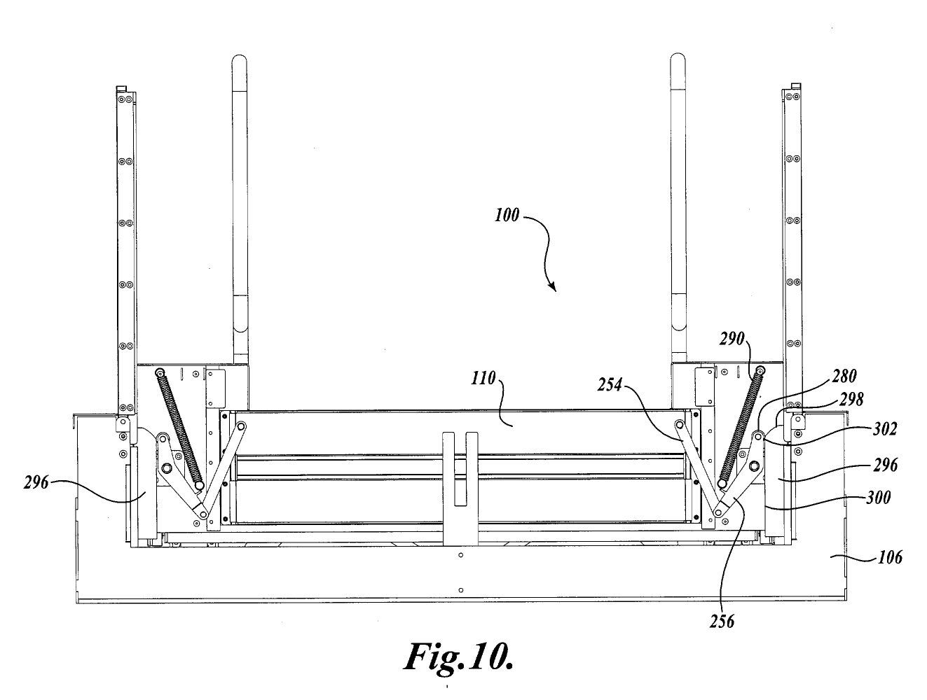

As may be seen by referring to FIGS. 10-12, angular rotation of the second lever 256 is controlled by a pair of cam plates 296 coupled to the frame 106. Inasmuch as the cam plates 296 are mirror images of each other, only one cam plate 296 will be described in greater detail. Each cam plate 296 includes a cam surface 298 and a stop surface 300. The cam follower 280 coupled to the lower end of the second lever 256 rides upon the cam surface 298 and the stop surface 300 to selectively control the deployment of the lift platform barrier 110.

More specifically, as the lift platform 108 is raised, the lift platform barrier actuating assembly 136 is also elevated since it is coupled to the lift platform 108. As the lift platform 108 rises, the separation distance between the lift platform barrier actuating assembly 136 and the cam plate 296, which is coupled to a stationary portion of the frame 106, is increased. This causes the cam follower 280 to ride vertically along the stop surface 300. As the cam follower 280 rides vertically along the stop surface 300, the second lever 256 does not rotate and the lift platform barrier 110 remains stationary in the stowed (retracted) position.

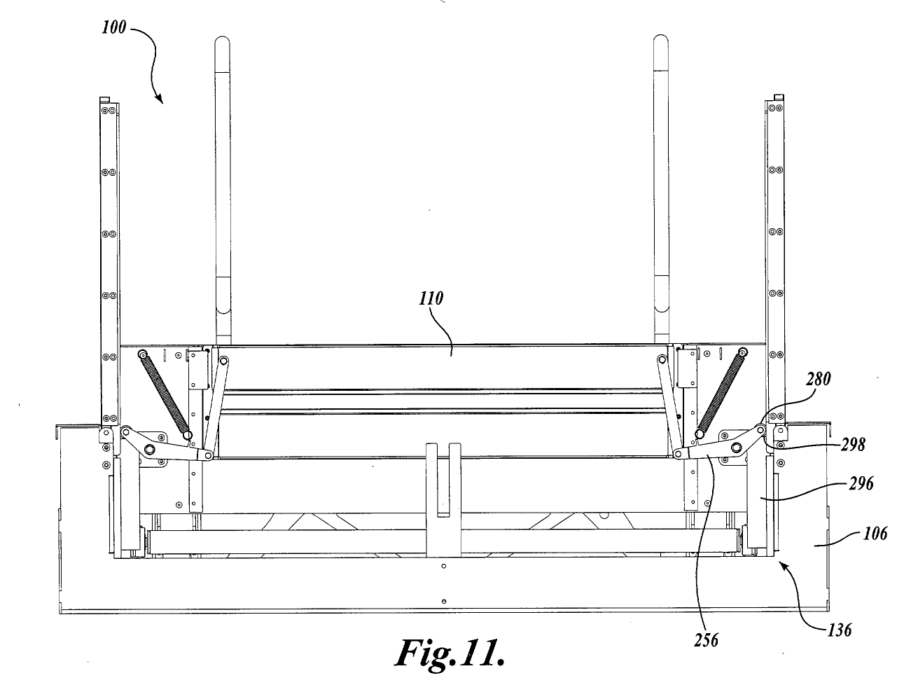

As the lift platform 108 is raised further, the cam follower 280 eventually passes over a ridge 302 marking the transition of the stop surface 300 to the cam surface 298. As the cam follower 280 passes onto the cam surface 298, the second lever 256 begins to rotate about the pivot shaft 272. The cam follower 280 is biased by a spring 290 to engage the stop surface 300 and the cam surface 298. As the cam follower 280 passes along the cam surface 298 and is rotated, the first lever 254 rotates and is driven along its length as the cam follower 280 rides along the cam surface 298, thereby actuating the lift platform barrier 110 from its stowed position to its partially deployed position shown in FIG. 11.

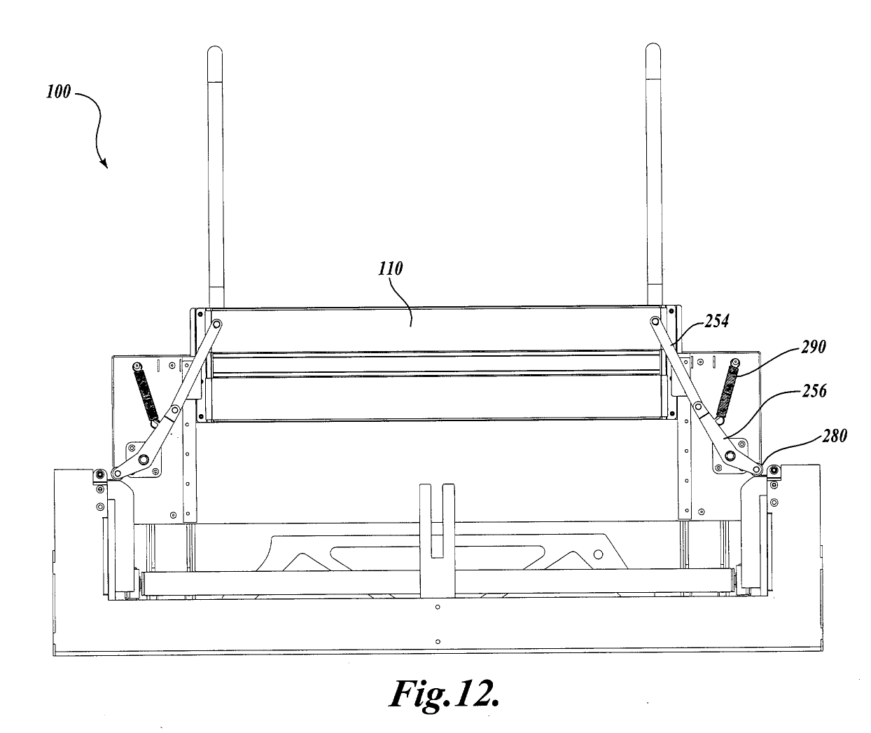

Referring to FIGS. 11 and 12, as the lift platform 108 is raised above the elevation depicted in FIG. 11, the cam follower 280 disengages from the cam surface 298 of the cam plate 296. When the cam follower 280 disengages from the cam surface 298, the second lever 256 biased by spring 290 is free to rotate about the pivot shaft 272, causing the lift platform barrier 110 to be actuated from the partially deployed position shown in FIG. 11 to the fully deployed position shown in FIG. 12.

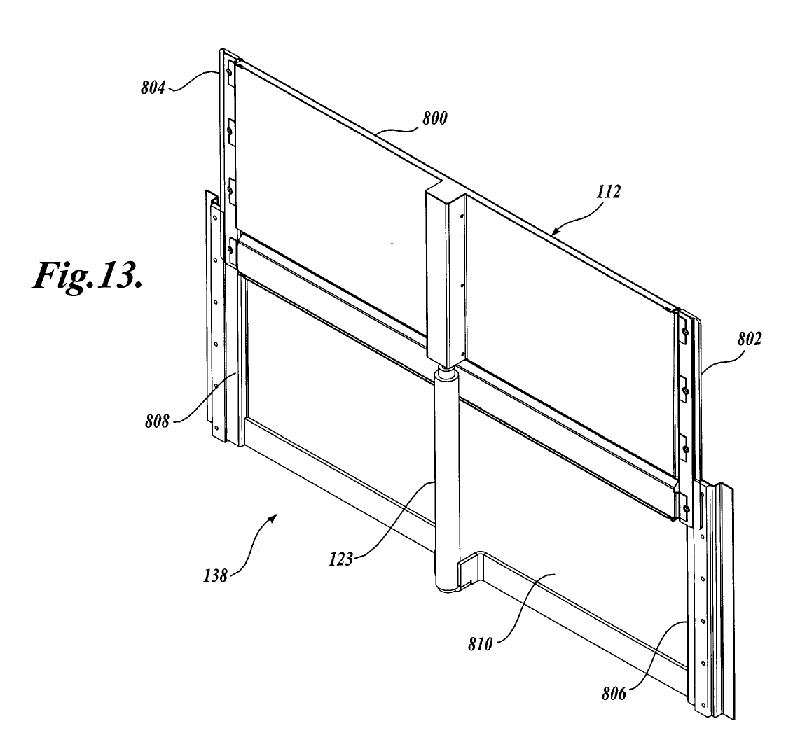

As may be best seen by referring to FIG. 13, the upper floor barrier assembly 138 includes a barrier 112 and an actuator 123. The barrier 112 includes a plate 800 and first and second slide plates 802 and 804. The plate 800 is suitably rectangular in configuration and form from a well known material, such as aluminum. The first and second slide plates 802 and 804 are suitably attached to opposite ends of the plate 800 by well known fasteners (not shown), such as rivets or bolts. The first and second slide plates 802 and 804 are positioned for sliding engagement with first and second slides 806 and 808 of an anchor plate 810.

The first and second slides 806 and 808 are fastened to opposite ends of the anchor plate 810, such that edge portions of the first and second slide plates 802 and 804 are slidably positioned between opposing ends of the first and second slides 806 and 808 and corresponding sides of the anchor plate 810. The actuator 123 is anchored to a portion of the anchor plate 810 and is operatively coupled to the barrier 112, such that actuation of the actuator 123 selectively displaces the barrier 112 into and out of the deployed position.

Referring back to FIG. 5, the cover panel actuating assembly 139 will now be described in greater detail. The cover panel actuating assembly 139 includes a pair of actuators 304a and 304b. Each actuator 304 is coupled to one end of each cover panel 116a and 116b. The upper end of each actuator 304 is coupled to lever arms 306 that are, in turn, pivotally coupled to a series of fulcrums 308 coupled to the frame 106. The lever arms 306 are rigidly coupled to respective cover panels 116a or 116b. A lower end of each actuator 304 is pivotally coupled to the frame 106.

The actuators 304 are selectively adjustable in length. Shortening the length of the actuators 304 relative to the length depicted in FIG. 5 causes the cover panels 116a and 116b to move from their stowed position to their deployed position. Likewise, lengthening the actuators 304 causes the cover panels 116a and 116b to move from the deployed position to the stowed position. In the illustrated embodiment, the actuators are formed from hydraulic pistons, however, it should be apparent to those skilled in the art that other actuators are suitable for use with and within the spirit and scope of the present invention, such as electrical solenoid actuators, mechanical actuators, etc. Further, although in the illustrated embodiment, the cover panels 116a and 116b are depicted as coupled to the frame 106 of the lift assembly 100, it should be apparent to those skilled in the art that the cover panels 116 may alternately be coupled to a structure other than the lift assembly 100, such as the lower floor 102.

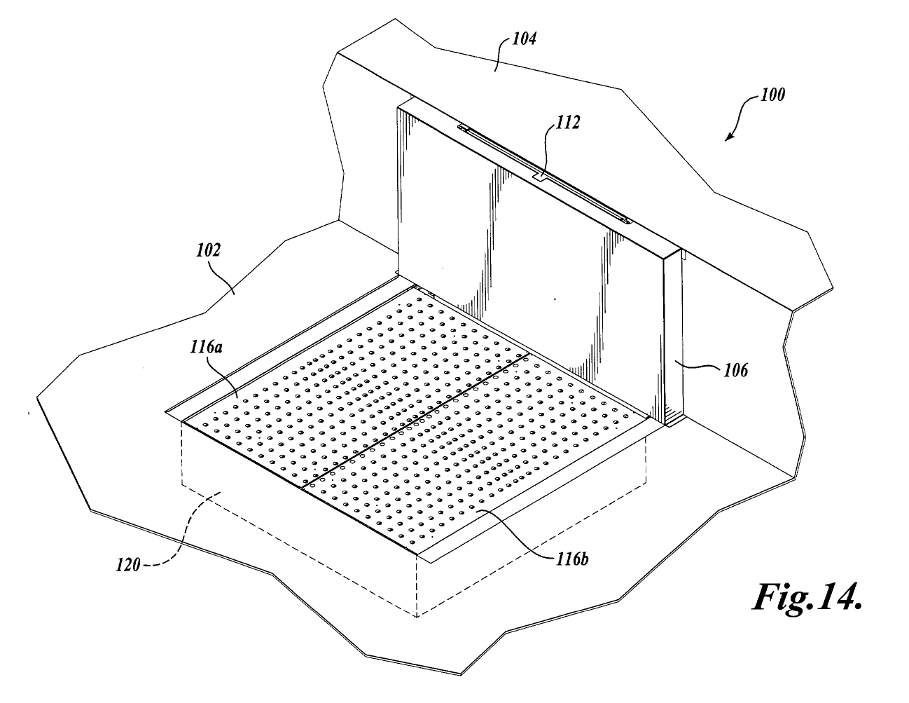

Operation of the lift assembly 100 may be best understood by referring to FIGS. 14-19. In FIG. 14, the lift assembly 100 is shown in a stowed position. In the stowed position, a majority of the lift assembly 100, such as the lift platform 108, lift platform barrier 110, side curbs 114, and protective apron 118, are disposed in a cavity 120 located below the lower floor 102. The cover panels 116a and 116b are shown in a stowed position, wherein the cover panels 116a and 116b are preferably oriented substantially coplanar (i.e. flush) with the lower floor 102 and extend over and cover the cavity 120.

Configured in this manner, a person may walk over the cavity 120, supported by the cover panels 116a and 116b, without encountering tripping hazards or falling into the cavity 120. Preferably, for aesthetics, the cover panels 116a and 116b are covered with a material that corresponds with the material of the adjacent flooring, such as wood, carpet, or tile. Alternately, the outer surface of the cover panels 116a and 116b may be textured to provide a slip resistant surface.

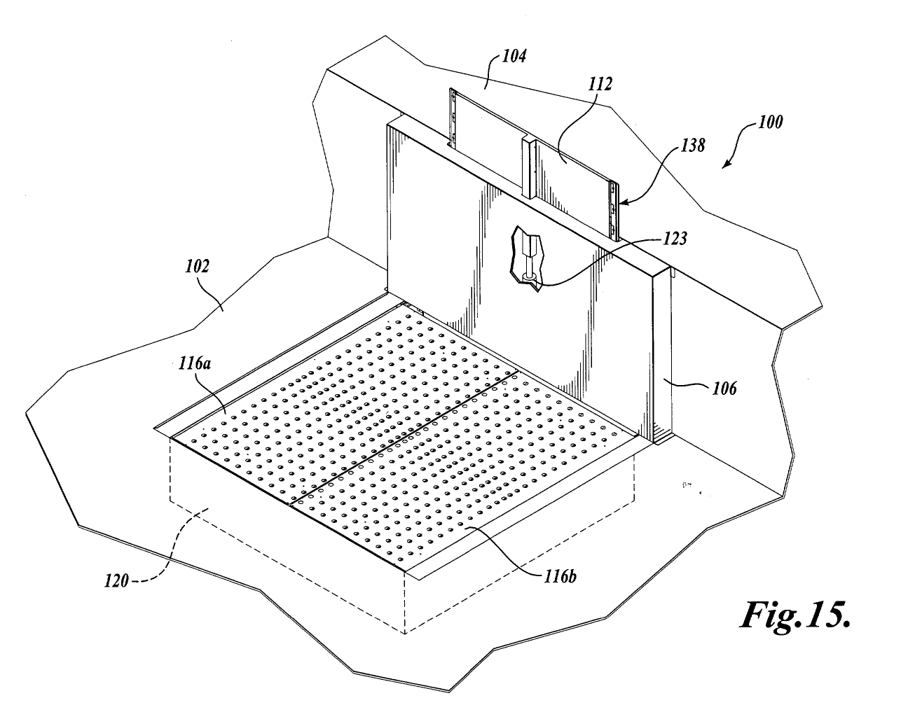

Referring now to FIG. 15, the lift assembly 100 is shown as the deployment of the lift assembly 100 is initiated. In a first stage of deployment of the lift assembly 100, the upper floor barrier 112 is actuated by a well known linear actuator 123, such as a hydraulic piston, from the stowed (retracted) position to the deployed (extended) position. In the deployed position, the upper floor barrier 112 extends above the upper floor 104 and is oriented substantially perpendicular to the upper floor 104. In the deployed position, the upper floor barrier 112 impedes a person from attempting to ingress the lift platform 108 prematurely, i.e. prior to arrival of the lift platform 108 to the upper floor 104. Further, the upper floor barrier 112 impedes objects from falling from the upper floor 104 and striking a person using the lift assembly 100. Further still, the upper floor barrier 112 also functions as a warning that the lift assembly 100 is in operation or is about to operate. Although the upper floor barrier 112 is described and depicted as being actuated from the stowed to the deployed position, it should be apparent to those skilled in the art that the upper floor barrier 112 may be deployed in alternate manners, such as by rotating the upper floor barrier 112 from the stowed to the deployed position.

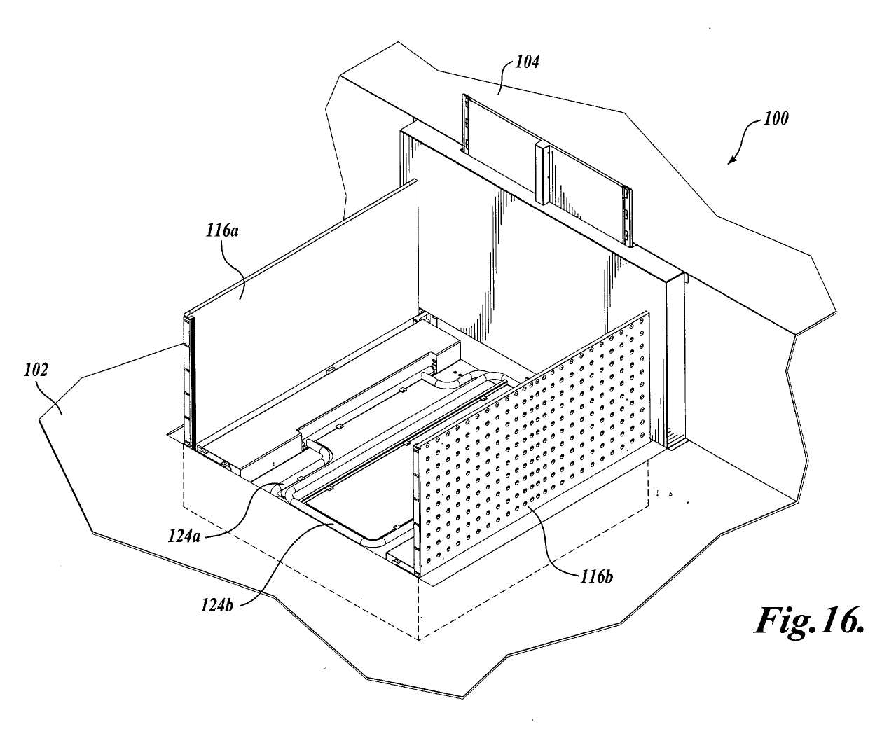

Referring now to FIG. 16, the lift assembly 100 is shown as the deployment of the lift assembly 100 enters a second stage of the deployment. In the second stage of deployment, the cover panels 116a and 116b are rotated from the stowed position depicted in FIGS. 14 and 15 to the deployed position shown in FIG. 16. In the deployed position, the cover panels 116a and 116b extend above the lower floor 102 and are oriented substantially perpendicular to the lower floor 102. Although the cover panels 116a and 116b are described and depicted as being rotated from the stowed to the deployed position, it should be apparent to those skilled in the art that the cover panels 116a and 116b may be deployed in alternate manners.

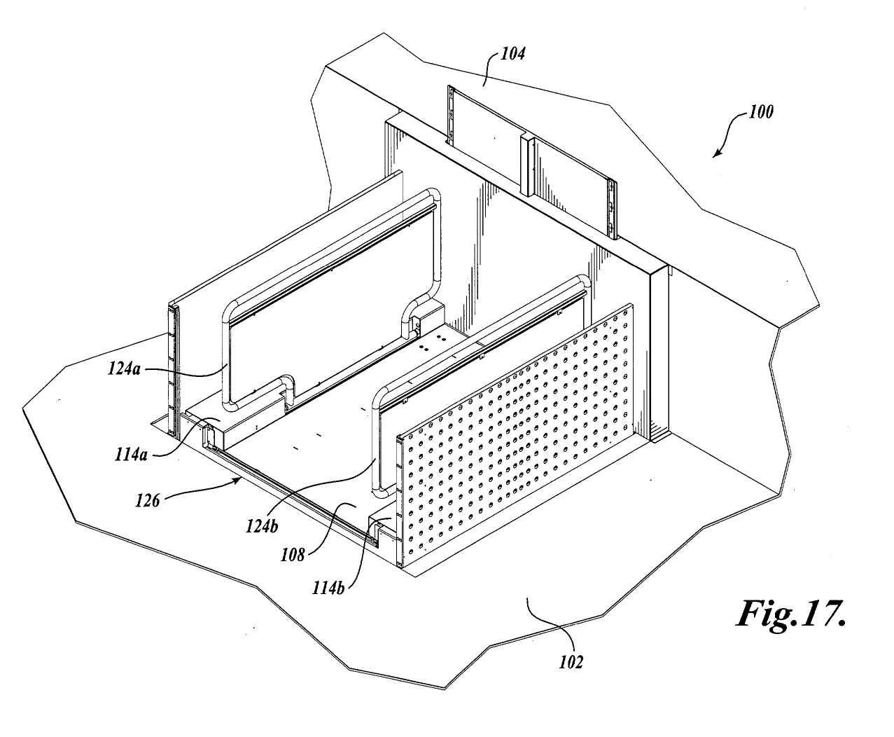

Referring now to FIG. 17, the lift assembly 100 is shown as the deployment of the lift assembly 100 enters a third stage of deployment. In the third stage of deployment, the handrails 124a and 124b are rotated from a stowed position to a deployed position. Referring to FIG. 16, in the stowed position, the handrails 124a and 124b are configured to be substantially parallel with the lift platform 108 and in an overlapping relationship, such that handrail 124a is located below handrail 124b. As the lift platform 108 is raised, the deployment of the handrails 124a and 124b commences, due to the overlapped relationship of the handrails 124a and 124b, the deployment of upper handrail 124b is initiated before the deployment of lower handrail 124a. The deployment of the handrails 124a and 124b is accomplished by rotating the handrails 124a and 124b to the deployed position shown in FIG. 17.

In the deployed position, the handrails 124a and 124b extend above the lift platform 108 and are oriented substantially perpendicular to the lift platform 108. Although the handrails 124a and 124b are described and depicted as being rotated from the stowed to the deployed position, it should be apparent to those skilled in the art that the handrails 124a and 124b may be deployed in alternate manners, such as linearly actuating each of the handrails 124a and 124b from the stowed to the deployed position.

Still referring to FIG. 17, as the lift platform 108 is raised, the handrails 124a and 124b are simultaneously actuated to the fully deployed position, to coincide when the lift platform 108 is located substantially coplanar with the lower floor 102. In this configuration, the lift assembly 100 is now ready to permit a wheelchair bound user to roll from the lower floor 102, across an entrance threshold 126, to the lift platform 108.

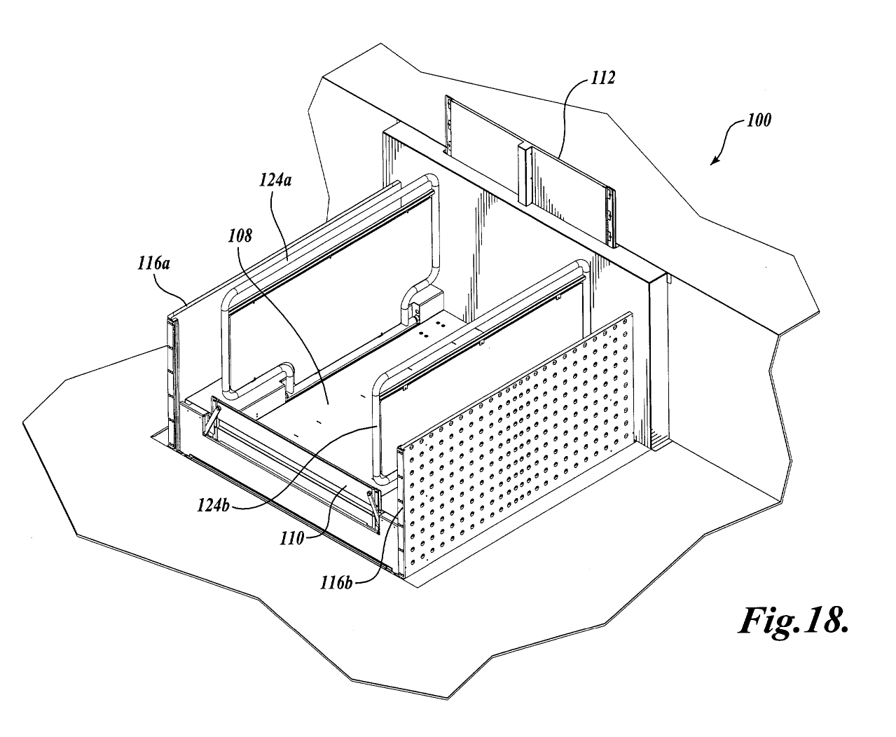

Referring now to FIG. 18, after the mobility impaired user is secured upon the lift platform 108, deployment of the lift assembly 100 enters a fourth stage. In the fourth stage of deployment, the lift platform barrier 110 is actuated from a stowed position depicted in FIG. 17 to the deployed position shown in FIG. 18. In the deployed position, the lift platform barrier 110 extends above the lift platform 108 and is oriented substantially perpendicular to the lift platform 108. In the deployed position, the lift platform barrier 110 impedes a person from attempting to egress from the lift platform 108 prematurely. Although the lift platform barrier 110 is described and depicted as being actuated from the stowed to the deployed position, it should be apparent to those skilled in the art that the lift platform barrier 110 may be deployed in alternate manners, such as by rotating the lift platform barrier 110 from the stowed to the partially deployed position. As the lift platform 108 is raised, the lift platform barrier is deployed simultaneously.

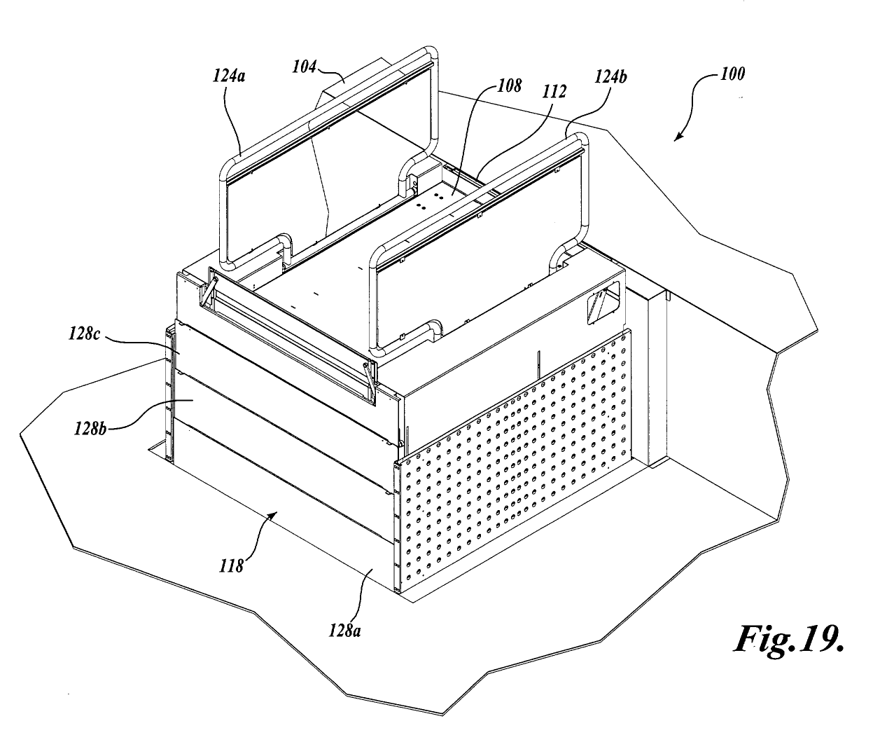

Referring now to FIG. 19, the lift platform 108 is raised until the lift platform 108 is substantially coplanar with the upper floor 104. As the lift platform 108 is raised, a protective apron 118 is formed below the lift platform 108. The protective apron 118 impedes a person or object from accessing portions of the lift assembly 100 during operation. This reduces the potential of injury to those in proximity to the lift assembly 100 and impedes the entrance of foreign objects within the lift assembly 100 that may cause damage or hamper operation of the lift assembly 100. In the illustrated embodiment of the present invention, the protective apron 118 is formed from a series of telescoping panels 128a, 128b and 128c. The panels 128 are coupled to the lift platform 108 and frame 106 such that the panels 128 slide relative to one another to form a protective barrier of adjustable height suspended from the lift platform 108. Although the protective apron 118 is described and depicted as a series of telescoping panels 128, it should be apparent to those skilled in the art that the protective apron 118 may take many other suitable forms, such as a panel linearly actuated upward at the same rate as the lift platform 108.

Referring now to FIG. 19, the lift assembly 100 is shown as the wheelchair bound person is permitted to egress from the lift platform 108. The lift platform 108 is substantially coplanar with the upper floor 104. To permit egress, the upper floor barrier 112 is linearly actuated from the deployed position shown in FIG. 18 to the stowed position shown in FIG. 19. In the stowed position, the upper floor barrier 112 is flush or slightly below the upper floor 104 so as to permit the wheelchair bound person to roll from the lift platform 108 and on to the upper floor 104.

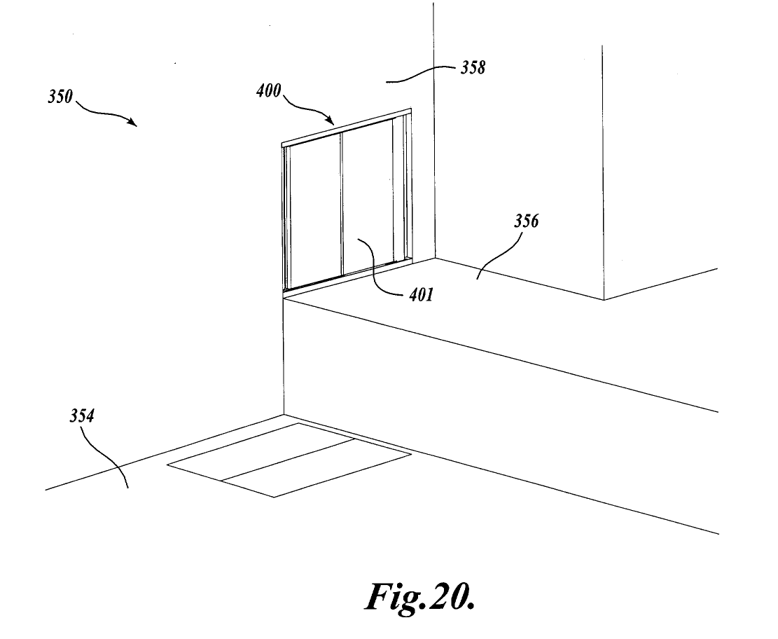

FIGS. 20-27 illustrate an alternate embodiment of the upper floor barrier assembly 138 of the previously described embodiment. The alternate embodiment of the upper floor barrier assembly 138 has been renamed for clarity as a retractable barrier assembly 400 to differentiate the alternate embodiment from the previous embodiment.

The retractable barrier assembly 400 is adapted for use in conjunction with a lift assembly 350. The lift assembly 350 identical in materials and operation as the lift assembly of the embodiment described above.

Although the illustrated embodiment of the retractable barrier assembly 400 is described as implemented in relation to a lift assembly 350, one skilled in the relevant art will appreciate that the disclosed retractable barrier assembly 400 is illustrative in nature and should not be construed as limited to application in relation to a lift assembly. It should therefore be apparent that the retractable barrier assembly 400 of the present embodiment has wide application, and may be used in any situation where a retractable barrier is desirable, such as use as a door, a fall prevention barrier, a roll stop, a protective cover, and so forth. It should be noted that for purposes of this disclosure, terminology such as upper, lower, side, horizontal, vertical, left, and, right, aft should be construed as descriptive and not limiting.

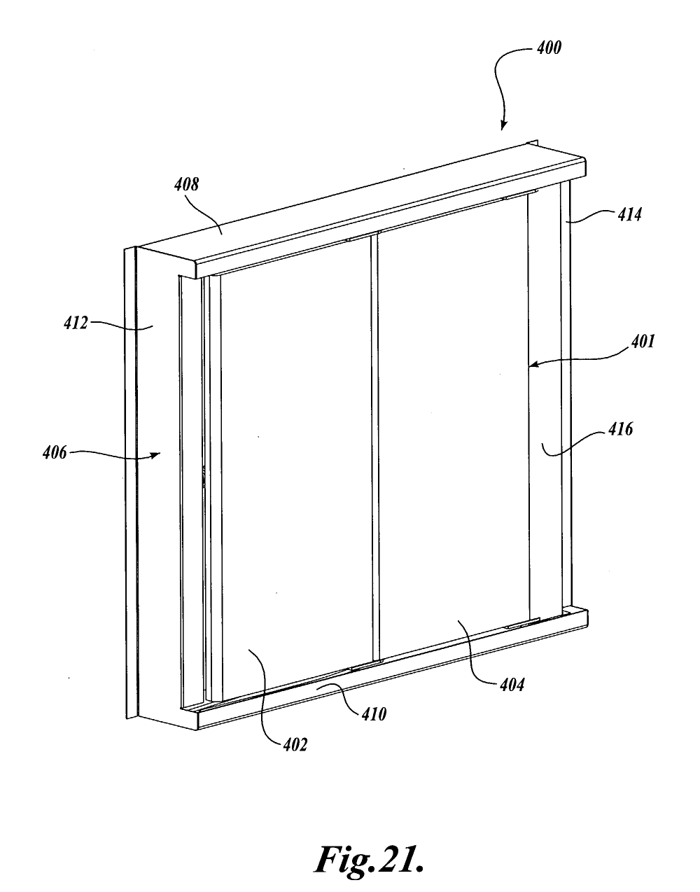

Referring to FIGS. 20 and 21, one embodiment of a retractable barrier assembly 400 formed in accordance with the present invention is depicted. The retractable barrier assembly 400 is attached to a wall 358 located adjacent and above a lift assembly 350. The retractable barrier assembly 400 includes a barrier 401. The barrier 401 is actuatable between a stowed position and a deployed position.

Preferably, the actuation of the barrier 401 is tied to the operation of the lift assembly 350. More specifically, as the lift assembly 350 is actuated from a stowed position to a fully raised position, the barrier 401 is deployed and stowed in accordance with the operation of the lift assembly 350. Moreover, the retractable barrier assembly 400 selectively deploys the barrier 401 to deter a person or object present on the upper floor 356 from inadvertently falling into or contacting the lift assembly 350 during actuation of the lift assembly 350. Further still, the actuation of the retractable barrier assembly 400 also functions as a warning that the lift assembly 350 is in operation or is about to operate.

Referring to FIG. 21, the structural components of the retractable barrier assembly 400 will now be discussed in further detail. The retractable barrier assembly 400 includes a barrier 401 formed from an outer panel 402 pivotally coupled to an inner panel 404. The barrier 401 is in turn coupled to a frame 406. The frame 406 is rectangular in shape and includes an upper frame member 408 oriented horizontally above the barrier 401. Oriented parallel with the upper frame member 408 and below the barrier 401 is a lower frame member 410. On one side of the barrier 401 is a vertically oriented first side frame member 412. On an opposite side of the barrier 401 is a vertically oriented second side frame member 414. The frame 406 may in turn be coupled to a structure such as a wall 358.

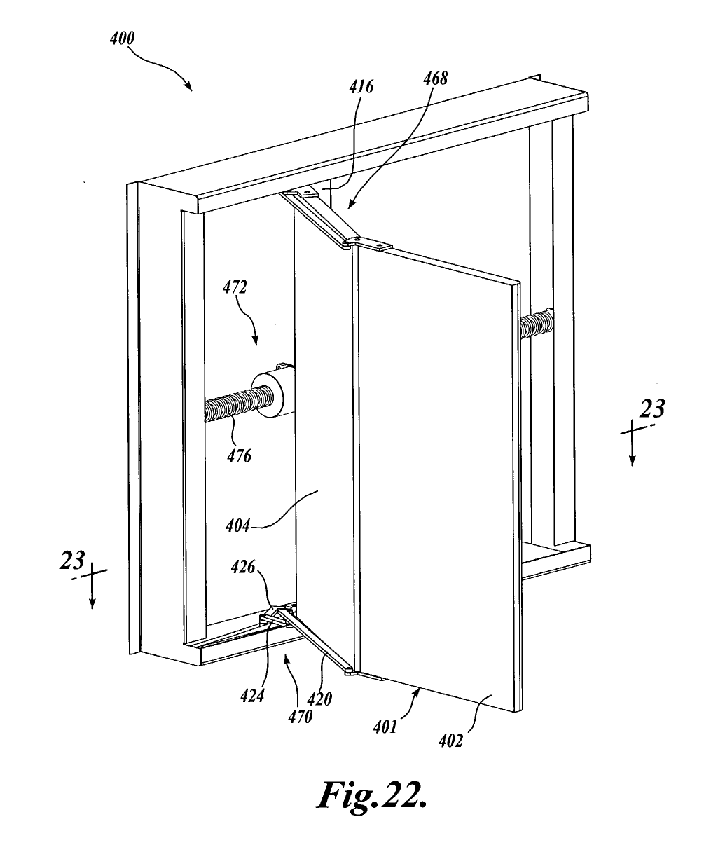

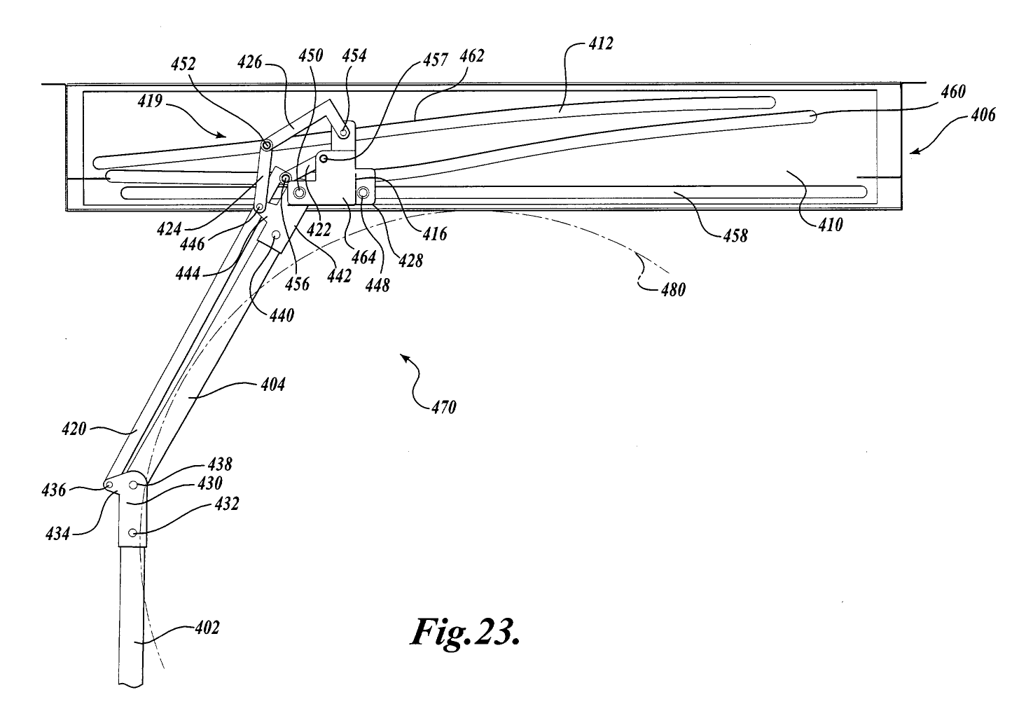

Referring to FIGS. 22 and 23, the barrier assembly 400 includes an upper and a lower actuating assembly 468 and 470. The elements of the upper and lower actuating assemblies 468 and 470 are mirror images of one another. Therefore, for brevity, only the lower actuating assembly 470 will be described in detail, as it should be apparent to one skilled in the art that reference in the following description to an element of the lower actuating assembly shall be understood as also referring to the corresponding mirrored element in the upper actuating assembly 468.

Each actuating assembly 468 and 470 includes a linkage assembly 419 actuated by a driven carriage 428. The linkage assembly 419 causes the outer panel 402 to pivot relative to the inner panel 404, and the inner panel 404 to pivot relative to the frame 406 in a bi-fold arrangement. The driven carriage 428 is reciprocated by a drive assembly 472. Movement of the driven carriage 428 longitudinally along the lower frame member 410 causes the linkage assembly 419 to configure the retractable barrier 401 from a deployed position to a stowed position, or vice versa, as desired by the user.

The driven carriage 428 includes a horizontally oriented flat plate 464. Extending perpendicularly downward from the flat plate 464 is a first guide 448 and a second guide 450. The guides 448 and 450 are sized and positioned to engage a carriage track 458 running longitudinally along the length of the lower frame member 410. The guides 448 and 450 guide the movement of the driven carriage 428 along the longitudinal path defined by the carriage track 458.

Pivotally coupled to guide 450 is a hinge plate 442. The inner panel 404 is coupled to the hinge plate 442 by a well known fastener 440. The hinge plate 442 also includes a boss 444 for permitting the pivotal coupling of an inner panel actuating link 424 to the boss 444 by a pivot pin 446. An outer panel connector link 422 is coupled to the driven carriage 428 by a pivot pin 457. Likewise, an inner panel connector link 426 is pivotally coupled to the driven carriage 428 by another pivot pin 454. As the driven carriage 428 is reciprocally driven along the path defined by the carriage track 458, the inner panel connector link 426 and the outer panel connector link 422 are forced to pivot about their attachment points to the driven carriage 428, i.e., pivot pin 454 and pivot pin 457, respectively. The pivoting of the inner panel connector link 426 and the outer panel connector link 422 in turn causes the rotation of inner and outer panels 404 and 402 between the stowed and deployed positions.

The degree and rate of rotation of the inner panel connector link 426 is controlled by a guide 452 disposed on an end of the inner panel connector link 426. The guide 452 engages and reciprocates within an inner panel linkage guide track 462. The inner panel linkage guide track 462 is formed in the lower frame member 410 and is arcuate in shape such that the distance separating the inner panel linkage guide track 462 from the carriage track 458 decreases as the driven carriage 428 is reciprocated in driving the barrier 401 from the stowed position to the fully deployed position. Thus, as the driven carriage 428 is reciprocated into the fully deployed position, the inner panel connector link 426 pivots in a counterclockwise rotation when viewed from above thereby acting upon the inner panel actuating link 424.

The inner panel actuating link 424 is pivotally coupled at guide 452 to the inner panel connector link 426. The inner panel actuating link 424 is also coupled at an opposing end to the boss 444 of the hinge plate 442 at pivot pin 446. Thereby, when the inner panel connector link 426 is rotated counterclockwise, the inner panel actuating link 424 imposes an outward force upon the boss 444 of the hinge plate 442, thereby rotating the hinge plate 442 and attached inner panel 404 about guide 450 of the driven carriage 428, rotating the inner panel 404 and attached outer panel 402 in a counterclockwise direction.

While the inner panel 404 is rotated by the linkage assembly 419 as described above, the outer panel 402 is likewise rotated in a counterclockwise direction in a similar manner as the inner panel 404 by the linkage assembly 419. More specifically, as the driven carriage 428 is reciprocated in driving the barrier 401 from the stowed to the fully deployed position, outer panel connector link 422 is forced to rotate about pivot pin 457. The rotation of the outer panel connector link 422 is controlled by a guide 456 disposed on an end of the outer panel connector link 422. The guide 456 engages and reciprocates within an outer panel linkage guide track 460. The outer panel linkage guide track 460 is formed in the lower frame member 410 and is arcuate in shape so that the distance separating the outer panel linkage guide track 460 from the carriage track 458 initially decreases as the driven carriage 428 is reciprocated longitudinally along lower frame member 410 and then slightly increasing as the driven carriage 428 approaches the fully deployed position.

Thus, as the driven carriage 428 is reciprocated toward a deployed position, the outer panel connector link 422 pivots initially in a counterclockwise rotation when viewed from above and subsequently in a clockwise rotation. An outer panel actuating link 420 is pivotally coupled at guide 456 to the outer panel connector link 422. The outer panel actuating link 420 is also coupled at an opposing end to the boss 434 of the hinge plate 430 at pivot pin 436. Thereby, when the outer panel connector link 422 is rotated counterclockwise, the outer panel actuating link 420 imposes an outward force upon the boss 434 of the hinge plate 430, thereby rotating the hinge plate 430 and attached outer panel 402 about pivot pin 438 and inner panel 404 in a counterclockwise direction when viewed from above. Likewise, as the driven carriage 428 approaches the fully deployed position, the outer panel connector link 422 is then rotated clockwise, the outer panel actuating link 420 imposes an inward force upon the boss 434 of the hinge plate 430, thereby rotating the hinge plate 430 and attached outer panel 402 about pivot pin 438 and inner panel 404 in a clockwise direction when viewed from above.

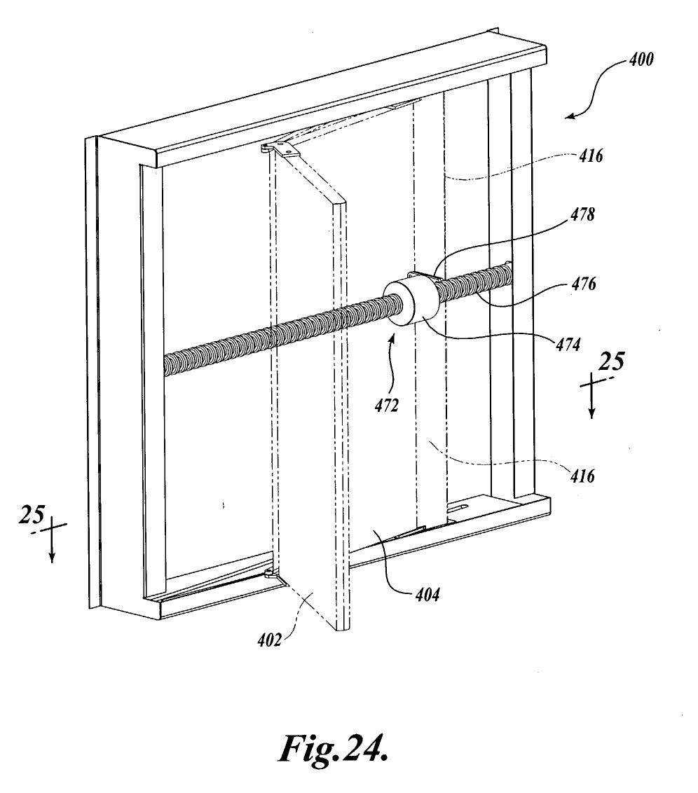

Referring to FIG. 24, the drive assembly 472 will now be discussed in further detail. The drive assembly 472 includes a motor 474 having a worm wheel (not shown) for engaging a worm 476 formed from an elongate helically threaded shaft. By selectively engaging the worm 476 with the worm gear, the drive assembly 472 may be selectively reciprocated along the length of the worm 476. An interface plate 478 permits the coupling of the drive assembly 472 to a driven member 416. The driven member 416 is a vertically disposed structural member coupled to the driven carriage 428 of the upper and lower actuating assemblies 468 and 470. Thus linear movement of the drive assembly 472 along the length of the worm 476 thereby causes likewise linear movement of the driven carriages 428 of the upper and lower actuating assemblies 468 and 470, causing the linkage assembly 419 to actuate the barrier 401 from the stowed to the deployed position, or vice versa.

In light of the above description of the components of the retractable barrier assembly 400, the operation of the retractable barrier assembly 400 during deployment will be described. Although the deployment of the barrier from the stowed to the deployed position will only be discussed in detail, it should be apparent to one skilled in the art that the reciprocation of the barrier 401 from the deployed to the stowed position is identical in all respects except the motions are performed in reverse, therefore the description of the deployment of the barrier 401 into the stowed position has been omitted for brevity.

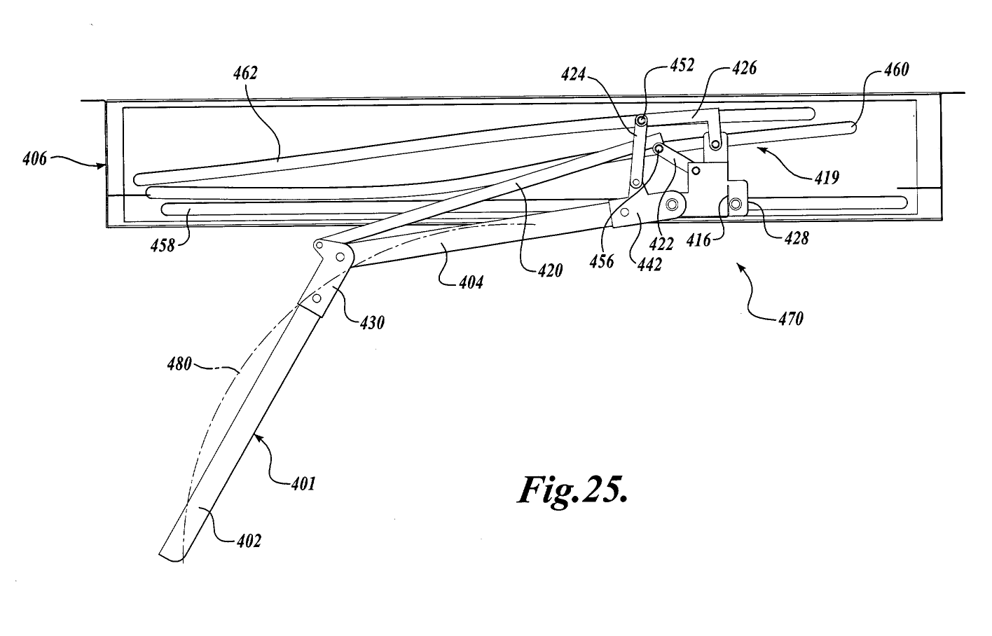

As the drive assembly 472 is activated, it is reciprocated along the length of the worm 476 and the attached driven member 416 is likewise reciprocated. Inasmuch as the driven carriage 428 is coupled to an end of the driven member 416, the driven carriage 428 is likewise displaced horizontally along the carriage track 458. As the driven carriage 428 is driven, the actuating assembly 470 is actuated from the stowed position, as depicted in FIGS. 20 and 21, to the 25% deployed position depicted in FIGS. 24 and 25. As the barrier 401 is reciprocated from the stowed to the deployed position, each panel 402 and 404 of the barrier 401 is selectively displaced while simultaneously rotated to deploy the panels 402 and 404 along an arcuate path shown in phantom and indicated by reference numeral 480. Of note, the arcuate path 480 is initially tangent to the plane containing the barrier 401 in the stowed position.

Still referring to FIGS. 24 and 25, this detailed description will now focus on the movement of the linkage assembly 419 as the barrier 401 is actuated from the stowed to the 25% deployed position. As described above, in actuating the barrier 401 from the stowed to the 25% deployed position, the driven carriage 428 is driven to the left along the carriage track 458. In doing so, the barrier 401 is reciprocated to the left and the inner panel connector link 426 is rotated counterclockwise (when viewed from above) through the interaction of guide 452 with the inner panel linkage guide track 462. The counterclockwise rotation of the inner panel connector link 426 in turn drives the inner panel actuating link 424 clockwise and linearly outward along its length, thereby pivoting the inner panel 404 counterclockwise along the arcuate path 480 through the interaction of the inner panel actuating link 424 with the hinge plate 442 to the 75% deployed position depicted in FIGS. 22 and 23.

Likewise, as the driven carriage 428 is driven, the outer panel connector link 422 is rotated counterclockwise through the interaction of guide 456 with the outer panel linkage guide track 460. The counterclockwise rotation of the outer panel connector link 422 in turn rotates and drives the outer panel actuating link 420 linearly to the left, thereby pivoting the outer panel 402 counterclockwise along the arcuate path 480 through the interaction of the outer panel actuating link 420 with the hinge plate 430 to the 75% deployed position in FIGS. 22 and 23.

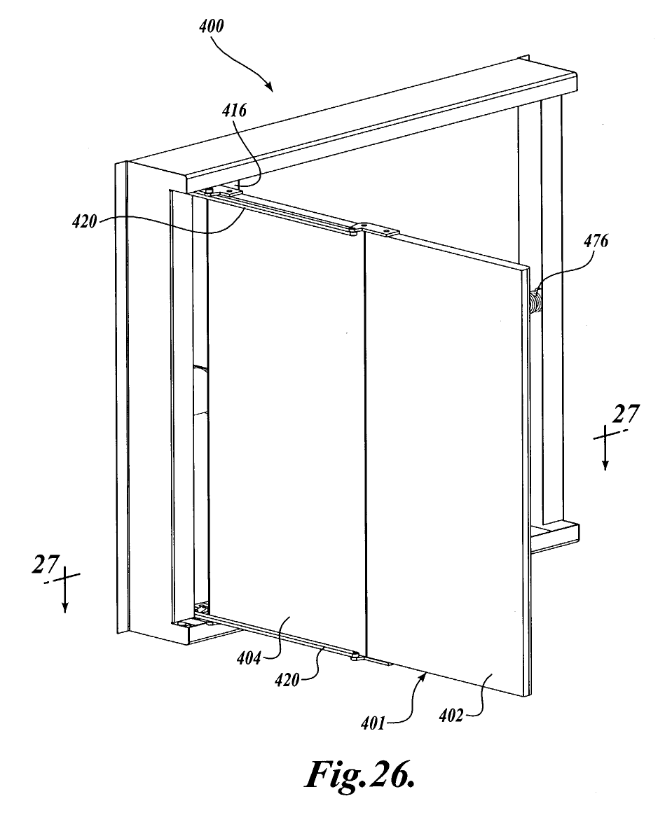

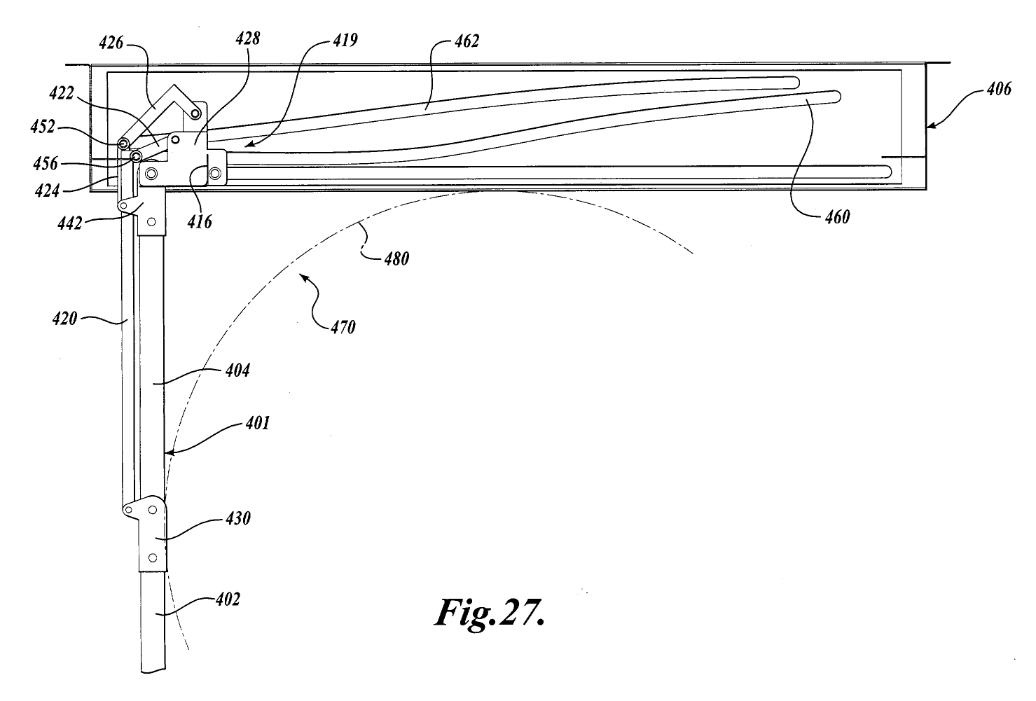

Referring to FIGS. 26 and 27, as the activation of the drive assembly 472 is continued, the drive assembly 472 is displaced further along the length of the worm 476. Inasmuch as the driven carriage 428 is coupled to the end of the drive member 416, the driven carriage 428 is likewise reciprocated to the left. As the driven carriage 428 is driven to the left, the actuating assembly 470 is actuated to the fully deployed position depicted in FIGS. 26 and 27. As the barrier 401 is actuated to the fully deployed position, the inner panel connector link 426 is rotated counterclockwise (when viewed from above) through the interaction of guide 452 with the inner panel linkage guide track 462. The counterclockwise rotation of the inner panel connector link 426 in turn drives the inner panel actuating link 424 clockwise and outward toward the hinge plate 442, thereby pivoting the inner panel 404 counterclockwise.

As the driven carriage 428 is driven farther to the left, the outer panel connector link 422 now changes direction of rotation and is now rotated clockwise through the interaction of guide 456 with the outer panel linkage guide track 460, which now slightly angles away from the guide track 458 to increase the distance separating the two tracks 458 and 460. The clockwise rotation of the outer panel connector link 422 in turn draws the outer panel actuating link 420 inward along its length away from hinge plate 430. This movement, in combination with the counterclockwise rotation of the inner panel 404, causes the distance separating pivot pin 438 from guide 456 to increase, thereby causing the outer panel 402 to now rotate clockwise.

As such, the barrier 401 is not swung outward as is done in previously designed retractable barriers, but is linearly reciprocated while simultaneously pivoted outward in a bi-fold manner as to define an arcuate travel path 480, preferably circular in shape. In scribing the arcuate path 480, the area required for deployment is greatly reduced. As the barrier 401 does not swing outward about a single pivot axis, the barrier 401 does not swing through the deployment area, causing damage or injury to any object or person located therein, or sweep any object or person located in the deployment area off the upper floor.

Although the illustrated embodiment of the present invention is depicted with a barrier 401 formed from two panels, it should be apparent to one skilled in the art that a barrier 401 formed from any number of panels may be utilized, such as a barrier formed from one panel, or three or more, without departing from the spirit and scope of the present invention. Further, although the arcuate path 480 scribed by the barrier 401 during deployment is arcuate in shape, and more specifically circular, it should be apparent to one skilled in the art that the path may contain linear segments in whole or part. Further still, although a specific actuation system was depicted in the illustrated embodiment, it should be apparent to one skilled in the art that any number and types of actuation systems are suitable for use with and are within the scope of the present invention, such as hydraulic, pneumatic, electrical, and magnetic actuation systems. Further still, although the retractable barrier assembly 400 of the present invention is described as being disposed upon a wall, it should be apparent to one skilled in the art that the retractable barrier assembly 400 may also be located upon a floor as well.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A wheelchair lift assembly disposed in a cavity located below a lower surface when in a stowed position, the wheelchair lift assembly comprising:
(a) a lift platform;
(b) a lifting mechanism coupled to the lift platform for reciprocating the lift platform between a lowered position, wherein the lift platform is substantially coplanar with the lower surface, and a raised position, wherein the lift platform is substantially coplanar with an upper surface;
(c) a lift platform barrier coupled to one end of the lift platform; and
(d) a lift platform barrier actuating assembly coupled to the lift platform barrier for actuating the lift platform barrier between a retracted position, wherein the lift platform barrier is disposed substantially flush or below the lift platform, and an extended position, wherein at least a portion of the lift platform barrier extends above the lift platform to impede ingress and egress from the lift platform.

2. The wheelchair lift assembly of claim 1, wherein the lift platform barrier actuating assembly includes an actuator for displacing the lift platform barrier between the retracted and extended positions.

3. The wheelchair lift assembly of claim 2, wherein the actuator includes a cam surface and a cam follower, wherein the cam follower engages the cam surface to selectively actuate the lift platform barrier between the retracted and extended positions.

4. The wheelchair lift assembly of claim 1, wherein the lifting mechanism is adapted to reciprocate the lift platform to a stowed position, wherein the lift platform is located below the lower surface.

5. The wheelchair lift assembly of claim 1, further comprising:
(a) a cover panel coupled to a frame;
(b) a cover panel actuating assembly coupled to the cover panel, the cover panel actuating assembly comprising an actuator adapted to reciprocate the cover panel between a stowed position, wherein the cover panel is substantially coplanar with the lower surface and oriented to extend over and at least partially cover the cavity, and a raised position, wherein the cover panel is inclined relative to the lower surface to impede access to the cavity.

6. The wheelchair lift assembly of claim 1, wherein the lifting mechanism comprises a scissors jack lifting device.

7. The wheelchair lift assembly of claim 1, further comprising a handrail coupled to the lift platform, the handrail reciprocal between a stowed position and a raised position.

8. The wheelchair lift assembly of claim 7, wherein the handrail is rotationally coupled to the lift platform such that the handrail is rotated between the stowed and raised positions.

9. The wheelchair lift assembly of claim 8, wherein the handrail is coupled to a torsion rod, the torsion rod adapted to exert a preload upon the handrail, the preload biasing the handrail toward the raised position.

10. The wheelchair lift assembly of claim 1, further comprising a handrail coupled to the lift platform, the handrail coupled to a handrail actuating assembly for actuating the handrail between a stowed position and a raised position.

11. The wheelchair lift assembly of claim 10, wherein the handrail actuating assembly comprises a cam surface and a cam follower, wherein the cam follower engages the cam surface to selectively actuate the handrail between the stowed and raised positions.

12. The wheelchair lift assembly of claim 10, wherein the handrail actuating assembly comprises a first lever coupled to the handrail, a second lever coupled to the lift platform, and a third lever coupled to the first and second levers, wherein when the second and third levers are substantially aligned, the handrail is impeded from actuating between the stowed and raised positions.

13. The wheelchair lift assembly of claim 1, further comprising a first and a second handrail coupled to the lift platform, the first and second hand rails each reciprocal between a stowed position and a raised position, wherein when the handrails are in the stowed position, the first handrail overlaps the second handrail.

14. The wheelchair lift assembly of claim 1, further comprising:
(a) an upper surface barrier in communication with the lifting mechanism; and
(b) an upper surface barrier actuating assembly coupled to the upper surface barrier for reciprocating the upper surface barrier between a stowed position and an extended position, wherein the upper surface barrier extends above the upper surface to impede access to the lift platform.

15. The wheelchair lift assembly of claim 14, wherein the upper surface barrier actuating assembly includes an actuator for linearly actuating the upper surface barrier between the stowed and extended positions.

16. The wheelchair lift assembly of claim 1, further comprising a telescoping apron coupled to the lift platform, the telescoping apron comprising a first panel and a second panel, wherein the first panel slides relative to the second panel to form a protective barrier of adjustable height suspended from the lift platform.

17. The wheelchair lift assembly of claim 1, wherein the lift platform barrier actuating assembly includes a barrier activation member, wherein when a height of the lift platform above the lower surface exceeds a selected height, the barrier activation member moves in a selected direction to actuate the lift platform barrier from the stowed position to the raised position.

18. A wheelchair lift assembly reciprocally disposed in a cavity located below a lower surface when in a stowed position, the wheelchair lift assembly comprising:
(a) a lift platform;
(b) a lifting mechanism coupled to the lift platform for actuating the lift platform between a lowered position, wherein the lift platform is substantially coplanar with the lower surface, and a raised position, wherein the lift platform is substantially coplanar with an upper surface;
(c) an upper surface barrier in communication with the lifting mechanism; and
(d) an upper surface barrier actuating assembly coupled to the upper surface barrier for actuating the upper surface barrier between a stowed position, wherein the upper surface barrier is disposed substantially flush or below the upper surface, and an extended position, wherein the upper surface barrier extends above the upper surface to impede ingress and egress from the lift platform.

19. The wheelchair lift assembly of claim 18, further comprising:
(a) a lift platform barrier coupled to one end of the lift platform; and
(b) a lift platform barrier actuating mechanism coupled to the lift platform barrier for actuating the lift platform barrier between a retracted position, wherein the lift platform barrier is disposed substantially flush or below the lift platform to permit ingress and egress from the lift platform, and an extended position, wherein at least a portion of the lift platform barrier extends above the lift platform to impede ingress and egress from the lift platform.

20. The wheelchair lift assembly of claim 19, wherein the lift platform barrier actuating assembly includes an actuator for linearly displacing the lift platform barrier between the retracted and extended positions.

21. The wheelchair lift assembly of claim 20, wherein the actuator comprises a cam surface and a cam follower, wherein the cam follower engages the cam surface to selectively actuate the lift platform barrier between the retracted and extended positions.

22. The wheelchair lift assembly of claim 18, wherein the lifting mechanism is adapted to reciprocate the lift platform to a stowed position, wherein the lift platform is located below the lower surface.

23. The wheelchair lift assembly of claim 18, further comprising:
(a) a cover panel coupled to the frame; and
(b) a cover panel actuating assembly coupled to the cover panel, the cover panel actuating assembly adapted to reciprocate the cover panel between a stowed position, wherein the cover panel is substantially coplanar with the lower surface and oriented to extend over and at least partially cover the cavity, and a raised position, wherein the cover panel is inclined relative to the lower surface to impede access to the cavity.

24. The wheelchair lift assembly of claim 18, wherein the lifting mechanism comprises a scissors jack lifting device.

25. The wheelchair lift assembly of claim 18, further comprising a handrail coupled to the lift platform, the handrail reciprocal between a stowed position and a raised position.

26. The wheelchair lift assembly of claim 25, wherein the handrail is rotationally coupled to the lift platform such that the handrail is rotated between the stowed and raised positions.

27. The wheelchair lift assembly of claim 26, wherein the handrail is coupled to a torsion rod, the torsion rod adapted to exert a preload upon the handrail, the preload biasing the handrail toward the raised position.

28. The wheelchair lift assembly of claim 18, further comprising a handrail coupled to the lift platform, the handrail coupled to a handrail actuating assembly for actuating the handrail between a stowed position and a raised position.

29. The wheelchair lift assembly of claim 28, wherein the handrail actuating assembly comprises a cam surface and a cam follower, wherein the cam follower engages the cam surface to selectively actuate the handrail between the stowed and raised positions.

30. The wheelchair lift assembly of claim 28, wherein the handrail actuating assembly comprises a first lever coupled to the handrail, a second lever coupled to the lift platform, and a third lever coupled to the first and second levers, wherein when the second and third levers are substantially aligned, the handrail is impeded from actuating between the stowed and raised positions.

31. The wheelchair lift assembly of claim 18, further comprising a first and a second handrail coupled to the lift platform, the first and second hand rails each reciprocal between a stowed position and a raised position, wherein when the handrails are in the stowed position, the first handrail overlaps the second handrail.

32. The wheelchair lift assembly of claim 18, wherein the upper surface barrier actuating assembly includes an actuator for linearly displacing the upper surface barrier between the stowed and extended positions.

33. The wheelchair lift assembly of claim 18, further comprising a telescoping apron coupled to the lift platform, the telescoping apron comprising a first panel and a second panel, wherein the first panel slides relative to the second panel to form a protective barrier of adjustable height suspended from the lift platform.

34. The wheelchair lift assembly of claim 18, wherein the upper surface barrier actuating assembly actuates the upper surface barrier from the raised position to the stowed when the lift platform is substantially coplanar with the upper surface.

35. A wheelchair lift assembly disposed in a cavity located below a lower surface, the wheelchair lift assembly comprising:
(a) a frame;
(b) a lift platform coupled to the frame, the lift platform actuatable between a lowered position, wherein the lift platform is substantially coplanar with the lower surface, and a raised position, wherein the lift platform is substantially coplanar with the upper surface;
(c) a handrail coupled to the lift platform, the handrail actuatable between a stowed position and a raised position;
(d) a lift platform barrier coupled to the lift platform, the lift platform barrier actuatable between a stowed position, wherein the lift platform barrier permits ingress and egress from the lift platform, and a raised position, wherein the lift platform barrier is inclined relative to the lift platform to impede access to the lift platform; and
(e) an actuating assembly coupled to the lift platform, handrail, and lift platform barrier, the actuating assembly adapted to configure the lift platform between the lowered and raised positions, the handrail between the stowed and raised positions, and the lift platform barrier between the stowed and raised positions.

36. The wheelchair lift assembly of claim 35, wherein the actuating assembly is adapted to sequentially initiate the actuation of the lift platform, handrail, and lift platform barrier.

37. The wheelchair lift assembly of claim 35, wherein the actuating assembly includes a handrail activation member, wherein when the height of the lift platform above the lower surface exceeds a selected height, the handrail activation member moves in a selected direction to actuate the handrail from the stowed position to the raised position.

38. The wheelchair lift assembly of claim 35, wherein the actuating assembly includes a barrier activation member, wherein when the height of the lift platform above the lower surface exceeds a selected height, the barrier activation member moves in a selected direction to actuate the lift platform barrier from the stowed position to the raised position.

39. The wheelchair lift assembly of claim 35, wherein the actuating assembly includes an actuator for linearly displacing the lift platform barrier between the retracted and extended positions.

40. The wheelchair lift assembly of claim 35, wherein the actuating assembly comprises a cam surface and a cam follower, wherein the cam follower engages the cam surface to selectively actuate the lift platform barrier between the retracted and extended positions.

41. The wheelchair lift assembly of claim 35, wherein the actuating assembly is adapted to reciprocate the lift platform to a stowed position, wherein the lift platform is located below the lower surface.

42. The wheelchair lift assembly of claim 35, further comprising:
(a) a cover panel coupled to the frame;
(b) a cover panel actuating assembly coupled to the cover panel, the cover panel actuating assembly adapted to reciprocate the cover panel between a stowed position, wherein the cover panel is substantially coplanar with the lower surface and oriented to extend over and at least partially cover the cavity, and a raised position, wherein the cover panel is inclined relative to the lower surface to impede access to the cavity.

43. The wheelchair lift assembly of claim 35, wherein the actuating assembly includes a lifting mechanism for actuating the lift platform between the lowered and raised positions, the lifting mechanism comprised of a scissors jack lifting device.

44. The wheelchair lift assembly of claim 35, wherein the handrail is rotationally coupled to the lift platform such that the handrail is rotated between the stowed and raised positions.

45. The wheelchair lift assembly of claim 35, wherein the handrail is coupled to a torsion rod, the torsion rod adapted to exert a preload upon the handrail, the preload biasing the handrail toward the raised position.

46. The wheelchair lift assembly of claim 35, wherein the actuating assembly comprises a cam surface and a cam follower, wherein the cam follower engages the cam surface to selectively actuate the handrail between the stowed and raised positions.

47. The wheelchair lift assembly of claim 35, wherein the actuating assembly comprises a first lever coupled to the handrail, a second lever coupled to the lift platform, and a third lever coupled to the first and second levers, wherein when the second and third levers are substantially aligned, the handrail is impeded from actuating between the stowed and raised positions.

48. The wheelchair lift assembly of claim 35, further comprising a second handrail coupled to the lift platform, the second hand rail reciprocal between a stowed position and a raised position, wherein when the first and second handrails are in the stowed position, the first handrail overlaps the second handrail.

49. The wheelchair lift assembly of claim 35, further comprising:
(a) an upper surface barrier in communication with the actuating assembly; and
(b) an upper surface barrier actuating assembly coupled to the upper surface barrier for reciprocating the upper surface barrier between a stowed position and an extended position, wherein the upper surface barrier extends above the upper surface to impede ingress and egress from the lift platform.

50. The wheelchair lift assembly of claim 49, wherein the upper surface barrier actuating assembly includes an actuator for linearly actuating the upper surface barrier between the stowed and extended positions.

51. The wheelchair lift assembly of claim 35, further comprising a telescoping apron coupled to the lift platform, the telescoping apron comprising a first panel and a second panel, wherein the first panel slides relative to the second panel to form a protective barrier of adjustable height suspended from the lift platform.

52. A combination wheelchair lift assembly and barrier assembly comprising:
(a) a frame;
(b) a lift platform reciprocally mounted to the frame for actuation between a lowered position and a raised position;
(c) a first barrier assembly coupled to one end of the lift platform, the first barrier assembly selectively actuatable between a raised position, wherein the first barrier impedes access to the lift platform, and a stowed position; and
(d) a second barrier in communication with the lift platform for selective deployment, the second barrier deployable between a stowed position and a deployed position, wherein access to the lift platform is impeded by the second barrier.

53. A combination wheelchair lift assembly and barrier assembly comprising:
(a) a frame;
(b) a lift platform reciprocally mounted to the frame for actuation between a lowered position and a raised position;
(c) a retractable barrier disposed in proximity to the lift platform, the retractable barrier selectively reciprocal between a deployed position to impede access to the lift platform and a stowed position to permit access to the lift platform, the retractable barrier comprising:
(i) a first panel having a pivot axis;
(ii) a second panel having a pivot axis; and
(d) an actuation assembly, the actuation assembly comprising a linkage assembly coupled to the retractable barrier, the linkage assembly adapted to reciprocate the retractable barrier between the deployed and stowed positions along a predetermined path by rotating each of the panels about their respective pivot axis and by displacing the first and second panels in a direction inclined relative to the pivot axes.

54. A barrier assembly for selectively impeding and permitting access to a selected area, the barrier assembly comprising:
(a) a retractable barrier comprising:
(i) a first panel having a pivot axis;
(ii) a second panel having a pivot axis; and
(b) an actuation assembly, the actuation assembly comprising a linkage assembly coupled to the retractable barrier, the linkage assembly adapted to reciprocate the retractable barrier between a stowed position to allow access to the selected area and a deployed position to impede access to the selected area along a predetermined path by rotating each of the panels about their respective pivot axis and by displacing the first and second panels in a direction inclined relative to the pivot axes.

55. The barrier assembly of claim 54, wherein the actuation assembly further comprises a first track arcuate in shape and the linkage assembly further comprises a first link coupled to the first panel, wherein when a first distal end of the first link reciprocates within the first track the first panel is rotated about its pivot axis and displaced in a direction inclined relative to its pivot axis.

56. The barrier assembly of claim 55, wherein the actuation assembly further comprises a second track arcuate in shape and the linkage assembly further comprises a second link coupled to the second panel, wherein when a first distal end of the second link reciprocates within the second track the second panel is rotated about its pivot axis and displaced in a direction inclined relative to its pivot axis.
